(19) United States
(12) Patent Application Publication
(10) Pub. No.: US 2012/0239952 A1
(43) Pub. Date: Sep. 20, 2012

(54) INFORMATION PROCESSING APPARATUS, POWER CONTROL METHOD, AND RECORDING MEDIUM

(75) Inventors: Naoki NISHIGUCHI, Kawasaki (JP); Noboru Iwamatsu, Kawasaki (JP); Masatomo Yasaki, Kawasaki (JP)

(73) Assignee: FUJITSU LIMITED, Kawasaki-shi (JP)

(21) Appl. No.: 13/352,604

(22) Filed: Jan. 18, 2012

(30) Foreign Application Priority Data
Mar. 17, 2011 (JP) 2011-059769

(51) Int. Cl. G06F 1/32

(52) U.S. Cl. 713/320

(57) ABSTRACT

A disclosed information processing apparatus includes a plurality of operating systems, a resource information storage part configured to store resource information including usage status information on hardware resources of the information processing apparatus, and a controller configured to specify at least one of the operating systems based on the resource information to report a resource release request of a desired one of the hardware resources to the specified operating system and receive a resource release report on the desired hardware resource from the specified operating system to control power associated with the desired hardware resource.

### CROSS-REFERENCE TO RELATED APPLICATION

This patent application is based upon and claims the benefit of priority of Japanese Patent Application No. 2011-059769 filed on Mar. 17, 2011, the entire contents of which are incorporated herein by reference.

### FIELD

The disclosures discussed herein are related to an information processing apparatus, a power control method and a recording medium storing a power control program.

### BACKGROUND

Recent virtual technologies along improved performance of central processing units (CPUs) have enabled one information processing apparatus to install multiple operating systems. Further, there are disclosed in the art various power control technologies to lower power consumption devised for recent information processing apparatuses. For example, the information processing apparatus installing multiple operating systems have high throughput rates. Hence, it may be important to utilize power control technologies for such an information processing apparatus. In the information processing apparatus installing multiple operating systems, each of the operating systems utilizes virtual resources, and a hypervisor that actually manages the resources performs power saving control.

There are known in the art a dynamic voltage and frequency scaling (DVFS) control technology to dynamically change operating frequency and voltage of a CPU or a partial array self refresh (PASR) control technology to refresh operating memory banks as examples of the power control in the information processing apparatus.

Further, there is also known in the art as a power control technology in the information processing apparatus, generating partitions in the systems and allocating at least several physical resources to the generated partitions by the hypervisor to save the power consumption of other physical resources that are not allocated to the partitions. Further, there is proposed as a power control technology in the information processing apparatus, some of the devices capable of lowering their power may be detected by allowing an operating status of each of the devices utilized in operating applications to match a standard operating status, and a message is presented to encourage setting the power to saving mode.

Patent Document 1: Japanese Laid-open Patent Publication No. 2004-192612

Patent Document 2: Japanese Laid-open Patent Publication No. 2007-179242

### SUMMARY

According to an aspect of an embodiment, there is provided an information processing apparatus that includes a plurality of operating systems installed therein; a resource information storage part configured to store resource information including usage status information on hardware resources of the information processing apparatus; and a controller configured to specify at least one of the operating systems based on the resource information to report a resource release request of a desired one of the hardware resources to the specified operating system and receive a resource release report on the desired hardware resource from the specified operating system to control power associated with the desired hardware resource.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

Additional objects and advantages of the embodiments will be set forth in part in the description which follows, and in part will be obvious from the description, or may be learned by practice of the invention.

### BRIEF DESCRIPTION OF THE DRAWINGS

FIG. 1 is a diagram illustrating a hardware configuration example of an information processing apparatus according to a first embodiment;

FIG. 2 is a block diagram illustrating a functional configuration example of the information processing apparatus according to the first embodiment;

FIG. 3 is a flowchart illustrating an example of a process carried out by a resource release part in the information processing apparatus according to the first embodiment;

FIG. 4 is a flowchart illustrating an example of a process carried out by a release resource specifying part in the information processing apparatus according to the first embodiment;

FIG. 5 is a flowchart illustrating an example of a process carried out by a resource manager in the information processing apparatus according to the first embodiment;

FIG. 6 is a flowchart illustrating an example of a process carried out by a user presenting part in the information processing apparatus according to the first embodiment;

FIG. 7 is a flowchart illustrating an example of a process carried out by a power controller in the information processing apparatus according to the first embodiment;

FIG. 8 is a diagram illustrating an example of resource information utilized in the information processing apparatus according to the first embodiment;

FIG. 9 is a diagram illustrating examples of a power saving determination threshold and a resource release request threshold utilized in the information processing apparatus according to the first embodiment;

FIG. 10 is a flowchart illustrating an example of a power saving control process by referring to the resource information in the information processing apparatus according to the first embodiment;

FIG. 11 is a block diagram illustrating a functional configuration example of the information processing apparatus according to a second embodiment;

FIG. 12 is a diagram illustrating an example of resource information utilized in the information processing apparatus according to the second embodiment;

FIG. 13 is a flowchart illustrating an example of a power saving control process by referring to the resource information in the information processing apparatus according to the second embodiment;

FIG. 14 is a diagram illustrating a hardware configuration example of an information processing apparatus according to a third embodiment;

FIG. 15 is a block diagram illustrating a functional configuration example of the information processing apparatus according to the third embodiment;

FIG. 16 is a diagram illustrating an example of resource information utilized in the information processing apparatus according to the third embodiment;

FIG. 17 is a flowchart illustrating an example of a power saving control process by referring to the resource information in the information processing apparatus according to the third embodiment;

FIG. 18 is a diagram illustrating a hardware configuration example of an information processing apparatus according to a fourth embodiment;

FIG. 19 is a block diagram illustrating a functional configuration example of the information processing apparatus according to the fourth embodiment;

FIG. 20 is a diagram illustrating an example of resource information utilized in the information processing apparatus according to the fourth embodiment;

FIG. 21 is a flowchart illustrating an example of a power saving control process by referring to the resource information in the information processing apparatus according to the fourth embodiment;

FIG. 22 is a block diagram illustrating a functional configuration example of an information processing apparatus according to a fifth embodiment;

FIG. 23 is a diagram illustrating an example of resource information utilized in the information processing apparatus according to the fifth embodiment;

FIG. 24 is a flowchart illustrating an example of a process carried out by a resource release part in the information processing apparatus according to the fifth embodiment;

FIG. 25 is a flowchart illustrating an example of a process carried out by a release resource specifying part in the information processing apparatus according to the fifth embodiment; and

FIGS. 26A and 26B are diagrams illustrating examples of replacement of resources.

### DESCRIPTION OF EMBODIMENTS

In the typical related art information processing apparatus having multiple operating systems, the hypervisor manages the power control process of the overall information processing apparatus and the operating systems do not manage the power saving control process. With this configuration, the CPU or memory may be ineffectually operated, and as a result, the power saving control may not be performed over the information processing apparatus efficiently. Moreover, if the power saving control is performed on the operating systems, the operating systems may in appropriately terminate applications to release the CPU or the memory, which may frequently restart the applications. Accordingly, the power consumption of the information processing apparatus may be increased.

As described above, in the related art information processing apparatus installing a plurality of operating systems, since the power saving control process performed on the operating systems is not directly applied to the information processing apparatus, the power control process of the information processing apparatus may not be efficiently managed.

### First Embodiment

In the following, a description is given with reference to the accompanying drawings of embodiments. In the following embodiments, a dynamic voltage and frequency scaling (DVFS) process is utilized as a power control process.

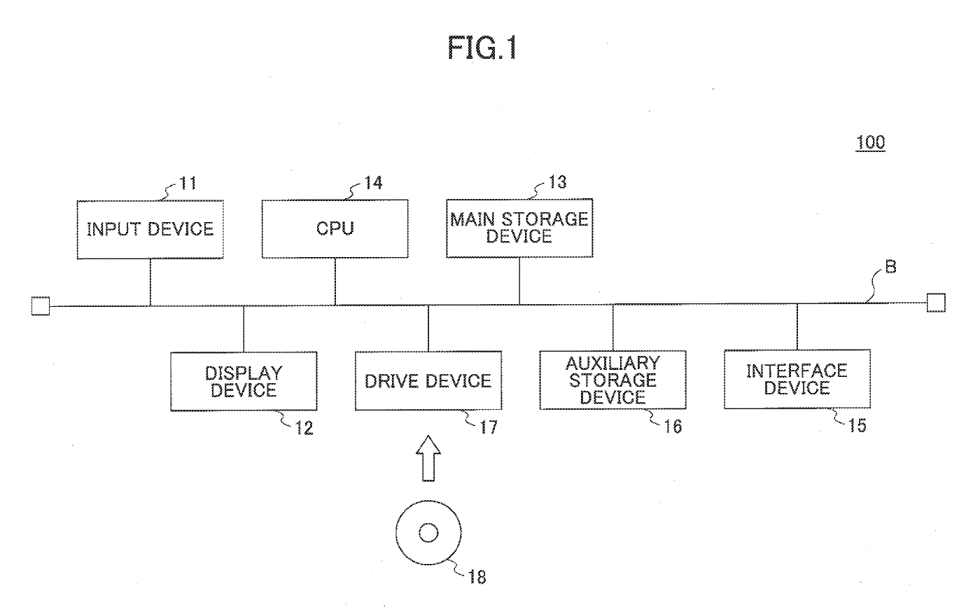

FIG. 1 is a diagram illustrating a hardware configuration example of an information processing apparatus according to a first embodiment.

An information processing apparatus 100 according to the first embodiment includes an input device 11, a display device 12, a main storage device 13, a CPU 14, an interface device 15, an auxiliary storage device 16 and a drive device 17 that are mutually connected via a bus B.

Thus, the input device 11, the display device 12, the main storage device 13, the CPU 14, the interface device 15, the auxiliary storage device 16 and the drive device 17 mutually connected via the bus B may be capable of mutually transmitting and receiving data under the control of the CPU 14. Note that the CPU 14 corresponds to a central processing unit (CPU) configure to control the overall operations of the information processing apparatus 100.

The interface device 15 is configured to receive data from other information processing apparatuses and transmit contents of the received data to the CPU 14. Further, the interface device 15 is configured to transmit data to other information processing apparatus based on instructions acquired from the CPU 14.

The auxiliary storage device 16 stores a power control program as a part of the programs for at least causing the information processing apparatus 100 to execute a power control process.

Thus, the information processing apparatus 100 having the above configuration includes a power control function, which is performed by allowing the CPU 14 to read the power control program from the auxiliary storage device 16 to execute the read power control program. Note that the power control program may be stored in the main storage device 13 that is accessible to the CPU 14. The input device 11 is configured to receive data under the control of the CPU 14. Further, the power control program may be stored in a recording medium 18 that may be read by the information processing apparatus 100.

Examples of the recording medium that may be read by the information processing apparatus 100 include a magnetic recording medium, an optical disk, a magneto-optical medium and a semiconductor memory. Examples of the magnetic recording medium include a hard disk drive (HDD), a flexible disk (FD) and a magnetic tape (MT). Examples of the optical disk include a digital versatile disc (DVD), a digital versatile disc random access memory (DVD-RAM), a compact disc-read only memory (CD-ROM) and a compact disc-recordable/rewritable memory (CD-R/CD-RW). Examples of the magneto-optical medium include a magneto-optical disk and the like. The power control program may be recorded in a portable recording medium 18 such as a DVD or CD-ROM for distributing the power control program.

In the information processing apparatus 100 executing the power control program, the drive device 17 may read the power control program from the recording medium 18. The CPU 14 stores the read power control program in the main storage device 13 or the auxiliary storage device 16.

The information processing apparatus 100 then reads the power control program stored in the main storage device or the auxiliary storage device 16 that is a storage device of the information processing apparatus 100 and executes processes based on the read power control program.

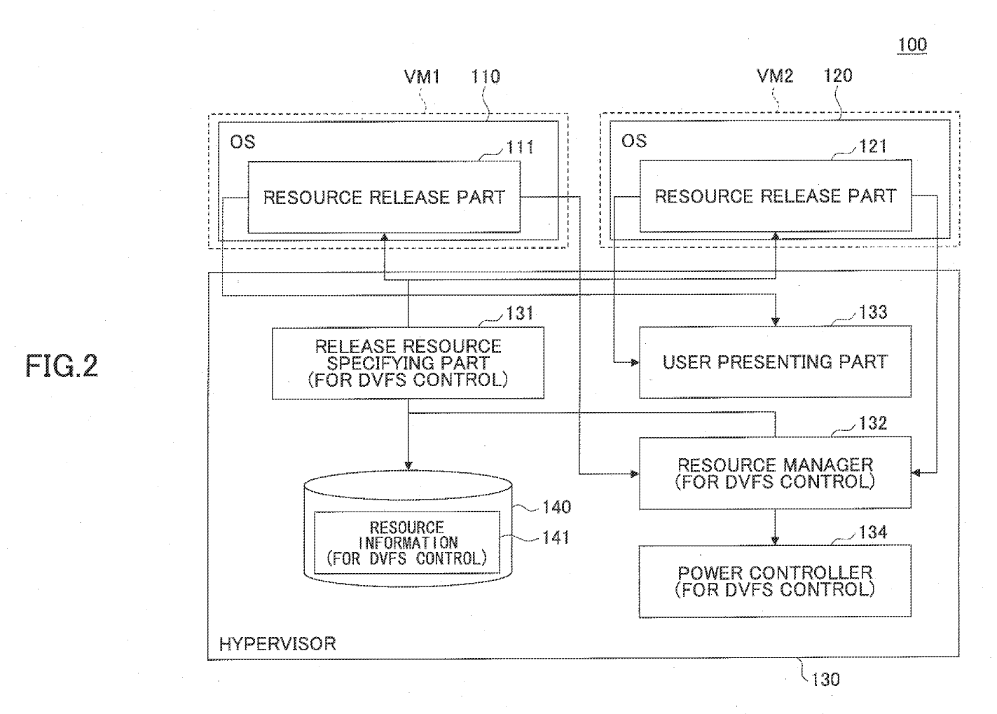

FIG. 2 is a block diagram illustrating a functional configuration example of the information processing apparatus according to the first embodiment.

The information processing apparatus 100 according to the first embodiment may be a mobile terminal configured to be driven by a secondary battery. The information processing apparatus 100 may be divided into a virtual machine VM1 and a virtual machine VM2, and hence the two different virtual machines VM1 and VM2 may execute different OS 110 and OS 120 in parallel. More specifically, the OS 110 may run in the virtual machine VM1 and the OS 120 may run in the virtual machine VM2. The hypervisor 130 is a control program for implementing the virtual machines VM1 and VM2, and causes the respective OS 110 and OS 120 to run in the virtual machine VM1 and the virtual machine VM2. That is, the hypervisor 130 is configured to serve as a controller to run multiple operating systems in the information processing apparatus 100.

The respective OS 110 and OS 120 include resource release parts 111 and 121. The resource release part 111 is configured to release the resources utilized by the OS 110 based on a resource release request described later. Likewise, the resource release part 121 is configured to release the resources utilized by the OS 120 based on the resource release request described later. When the resource release parts 111 and 121 release respective resources, a resource release report indicating that the resource release parts 111 and 121 have released the resources is transmitted to a resource manager 132.

Note that the resources indicate a generic name for hardware resources to sufficiently operate the CPU 14 or the storage devices of the information processing apparatus 100, and the resources in the information processing apparatus 100 according to the first embodiment indicate the CPU 14.

The hypervisor 130 includes the release resource specifying part 131, the resource manager 132, the user presenting part 133, the power controller 134 and the resource information storage part 140.

The release resource specifying part 131 is configured to specify an OS, to which the release resource specifying part 131 reports the resource release request, which is based on resource information 141 for DVFS control stored in the resource information storage part 140. The release resource specifying part 131 reports the resource release request to the resource release part of the specified OS.

The resource manager 132 is configured to manage resources stored in the resource information storage part 140 based on the resource information 141. The resource manager 132 is also configured to update the resource information 141. The user presenting part 133 is configured to present information associated with the release of the resources to a user. The power controller 134 is configured to control a power consumption process of the resources. Specifically, the power controller 134 performs a Dynamic Voltage and Frequency Scaling (DVFS) power control process for lowering the power consumption of the CPU 14 in the information processing apparatus according to the first embodiment. In the following description, the power control process to lower the power consumption of the resources is called a “power saving control” process.

The resource information storage part 140 is composed of the main storage device 13 and/or the auxiliary storage device 16, and configured to store the resource information 141. Details of the resource information 141 are described later.

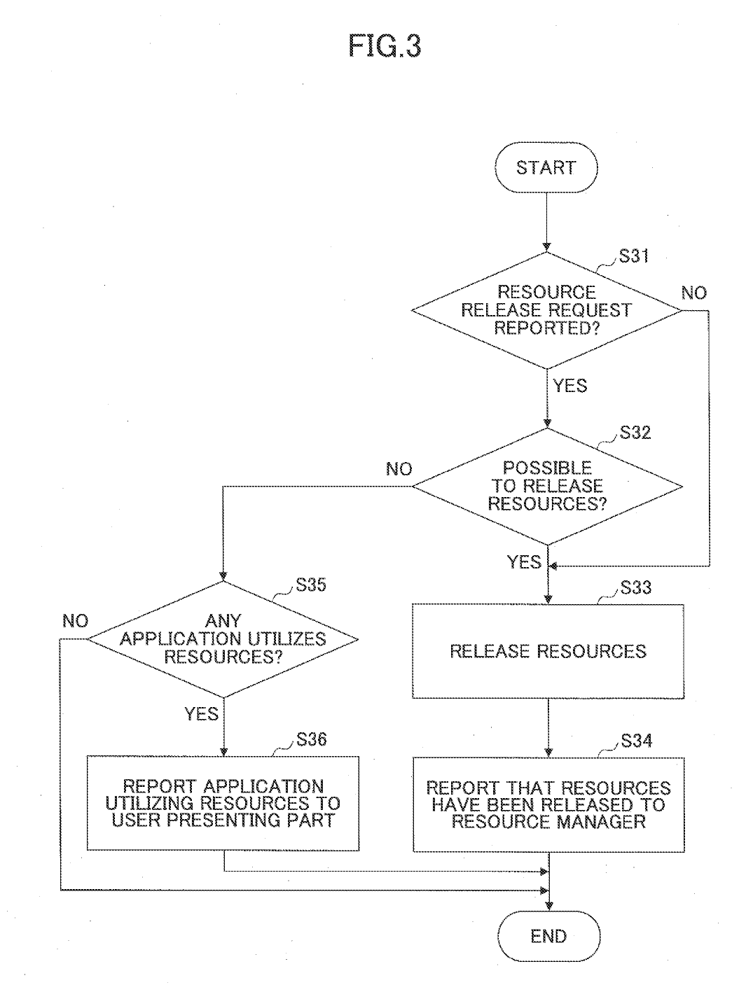

The processes carried out by the components of the information processing apparatus 100 are further described below. FIG. 3 is a flowchart illustrating an example of a process carried out by a resource release part in the information processing apparatus according to the first embodiment. Note that the resource release parts 111 and 121 include similar functional configurations. Thus, the process of the resource release part 111 is mainly described as an example of the resource release parts 111 and 121 and description of the process of the resource release part 121 is omitted in FIG. 3.

In the information processing apparatus 100 according to the first embodiment, when the resource release part 111 releases the resources, the resource release part 111 determines whether to release the resources based on a resource release request reported from the release resource specifying part 131 or a normal operation of the OS 110.

Initially, the resource release part 111 determines whether the resource release request is reported from the release resource specifying part 131 (step S131). If the resource release request is not reported from the release resource specifying part 131 in step S31 (“NO” in step S31), the resource release part 111 determines to release the resources based on the normal operation of the OS 110 and proceeds with the later-described process in step S33.

If, on the other hand, the resource release request is reported from the release resource specifying part 131 in step S31 (“YES” in step S31), the resource release part 111 determines whether it is possible to release the resources (i.e., the resources are releasable) (step S32). If the resource release part 111 determines that it is possible to release the resources (“YES” instep S32), the resource release part 111 releases the resources (step S33). Subsequently, the resource release part 111 transmits a resource release report indicating that the resources have been released to the resource manager 132 (step S34), and terminates the process (end of the process in FIG. 3).

If the resource release part 111 determines that it is not possible to release the resources (i.e., the resources are unreleasable) (“NO” in step S32), the resource release part 111 determines whether there is any application utilizing the resources (step S35). If the resource release part 111 determines that there is an application utilizing the resources (“YES” in step S35), the resource release part 111 reports the corresponding application utilizing the resources to the user presenting part 133 (step S36). If, on the other hand, the resource release part 111 determines that there is no application utilizing the resources (“No” in step S35), the resource release part 111 terminates the process (end of the process in FIG. 3).

Virtual machines may be separated into two major categories; one is a full-virtual machine that operates an OS without any modification and the other is a para-virtual machine that modifies a privileged instruction into a “hypercall” (i.e., the instruction is called to the hypervisor) and operates the OS based on the modified instruction. If the virtual machine is a full-virtual machine, the CPU generates exceptions when the privileged instruction is executed on the OS, which may enable the OS to transmit a report to the hypervisor. Further, in the full-virtual machine, a report may also be transmitted from the OS to the hypervisor by the hypercall.

Further, if the virtual machine is the para-virtual machine, a report maybe transmitted from the OS to the hypervisor by the hypercall. The hypercall may be implemented by utilizing a function of the CPU such as a software interrupt. The virtual machines VM1 and VM2 in the information processing apparatus 100 according to the first embodiment utilizes such a reporting function of the CPU to report the release of the resources and the like to the hypervisor 130.

The transmission of a report from the hypervisor to the virtual machines may be implemented by initiating the process from a handler of the OS. The hypervisor includes a function to switch virtual machines to be executed, and store or restore registers of the CPU when the hypervisor switches the virtual machines. The registers of the CPU include a program counter that stores the address that the CPU executes the instruction. Accordingly, the hypervisor may execute the handler of the OS by setting the program counter into the address of the handler of the OS. The hypervisor 130 in the information processing apparatus 100 according to the first embodiment may report the resource release request and the like to the OS 110 and OS 120 based on the reporting functions.

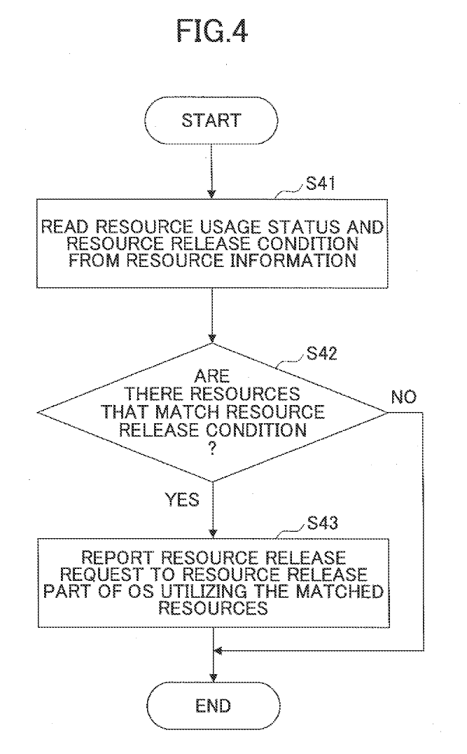

Next, the process of a release resource specifying part 131 is described below. FIG. 4 is a flowchart illustrating an example of a process carried out by the release resource specifying part 131 of the information processing apparatus according to the first embodiment.

The release resource specifying part 131 in the information processing apparatus 100 according to the first embodiment reads the resource information (step S41). Subsequently, the resource release part 131 determines whether there are resources to which the resource release request is reported based on the resource information 141 (step S42). If there are no resources that match the above resource release condition (i.e., there are no resources to which the resource release request is reported) (“NO” in step S42), the resource release part 131 terminates the process (end of the process in FIG. 4). If, on the other hand, there are resources that match the above resource release condition (i.e., there are resources to which the resource release request is reported) (“YES” instep S42), the resource release part 131 reports the resource release request to the corresponding resource release part of the OS that utilizes the matched resources (step S43). The release resource specifying part 131 in the information processing apparatus 100 according to the first embodiment carries out processes step S41 to S43 every time the resource manager 132 updates the resource information 141.

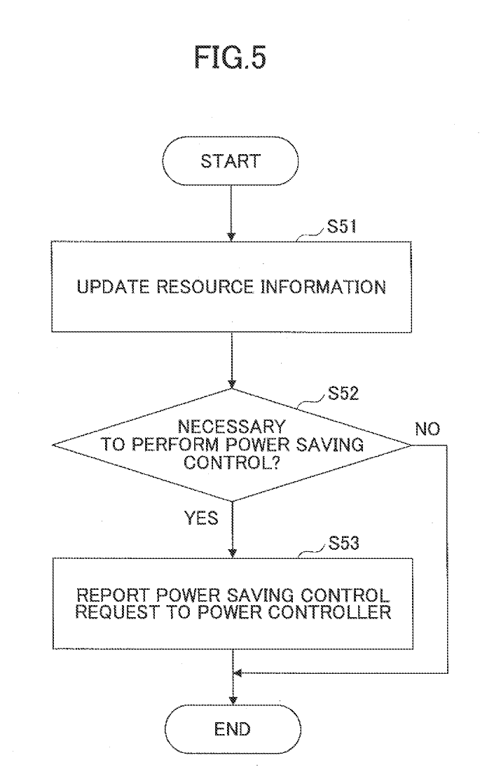

Next, the process of the resource manager 132 is described below. FIG. 5 is a flowchart illustrating an example of a process carried out by the resource manager 132 in the information processing apparatus according to the first embodiment.

The resource manager 132 in the information processing apparatus 100 according to the first embodiment acquires resource usage status information every predetermined period, and updates the resource information 141 stored in the resource information storage part 140 based on the acquired resource usage status information (step S51). For example, if the resource usage status information indicates that the resources are released, the resource manager 132 reflects the information indicating that the resources have been released in the resource information 141. On the other hand, if the resource usage status information indicates that the resources are acquired, the resource manager 132 reflects the information indicating that the resources have been acquired in the resource information 141.

Subsequently, the resource manager 132 determines whether it is necessary to perform the power saving control based on the resource information 141 (step S52). If the resource release part 132 determines that it is not necessary to perform the power saving control (“NO” in step S52), the resource manager 132 terminates the process (end of the process in FIG. 5). If, on the other hand, the resource release part 132 determines that it is necessary to perform the power saving control (“YES” in step S52), the resource manager 132 reports the power saving control request to the power controller 134 (step S53) and terminates the process (end of the process in FIG. 5).

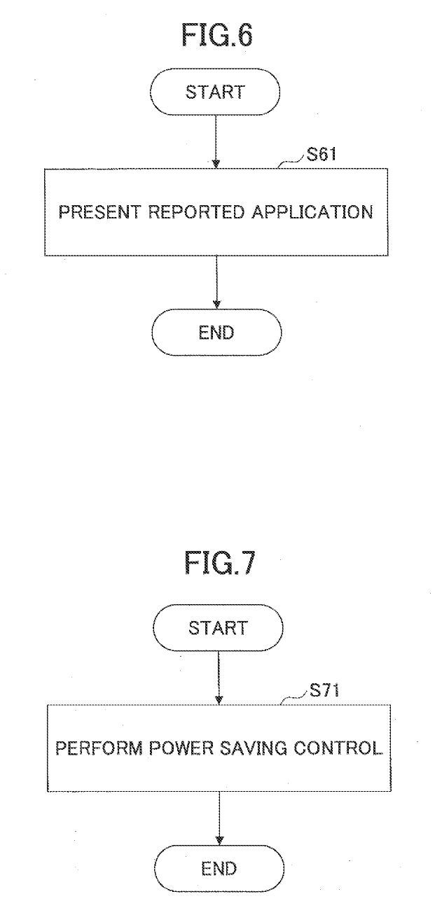

Next, the process of the user presenting part 133 is described below. FIG. 6 is a flowchart illustrating an example of a process carried out by the user presenting part 133 in the information processing apparatus according to the first embodiment.

The user presenting part 133 in the information processing apparatus 100 according to the first embodiment receives a report from at least one of the resource release parts 111 and 121 to initiate its operation. Specifically, the user presenting part 133 presents to a user information on the application reported from one of the resource release parts 111 and 121, and terminates the process (end of the process in FIG. 6). Alternatively, the user presenting part 133 may cause the display device 12 to display a user's operation for releasing the resources. For example, the user presenting part 133 may cause the display device 12 to display a message or the like to prompt the user to terminate the application in execution. Alternatively, the user presenting part 133 may cause the display device 12 to display a dialogue or the like to prompt the user to select one or more of the applications to terminate the selected applications. Further, the user presenting part 133 may prompt the user to perform the operations by an audio output to release resources.

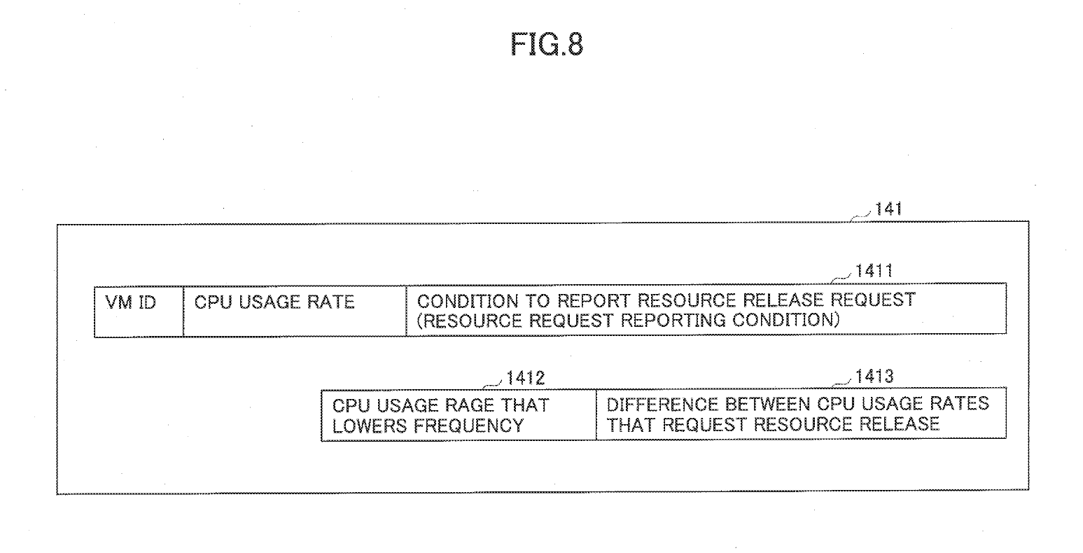

Next, the process of the power controller 134 is described below. FIG. 7 is a flowchart illustrating an example of a process carried out by the power controller 134 in the information processing apparatus according to the first embodiment.

The power controller 134 in the information processing apparatus 100 according to the first embodiment receives a report from the resource manager 132 to initiate its operation. Specifically, the power controller 134 receives a report from the resource manager 132 to perform the power saving control on the actual hardware (step S71), and terminates the process (end of the process in FIG. 7). The power controller 134 in the information processing apparatus 100 according to the first embodiment lowers the operating frequency of the CPU 14. Note that the power controller 134 in the information processing apparatus according to the first embodiment may alternatively lower the operating voltage of the CPU 14.

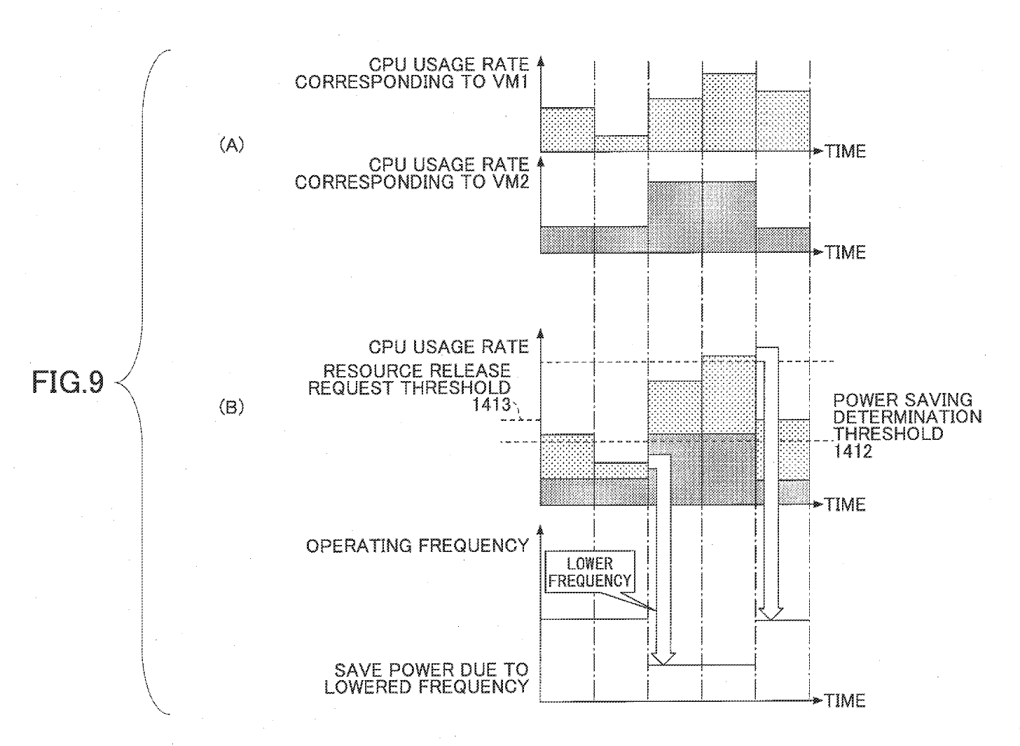

Next, the resource information 141 is described below. FIG. 8 is a diagram illustrating an example of the resource information 141.

The resource information 141 utilized in the information processing apparatus 100 according to the first embodiment includes individual resource information 1411, a power saving determination threshold 1412, and a resource release request threshold 1413.

The individual resource information 1411 includes information indicating the usage status of CPU 14 for each OS, which is stored corresponding to each OS. Thus, the resource information 141 utilized in the information processing apparatus 100 according to the first embodiment includes the individual resource information 1411 of the OS 110 and the individual resource information 1411 of the OS 120.

The individual resource information 1411 includes identifier information (ID) of the virtual machine installing the corresponding OS, the usage rate of the CPU 14, and a resource release request reporting condition for reporting the resource release request.

The resource release request reporting condition is a predetermined condition that is set to each OS in advance. For example, the resource release request reporting condition may be a value indicating a predetermined CPU usage rate or values indicating a predetermined range of the CPU usage rate. For example, if the usage rate of the CPU 14 corresponding to the OS 110 matches the predetermined value set in advance as the resource release request reporting condition, the OS 110 is selected as an OS to which the resource release request is reported. Alternatively, if the usage rate of the CPU 14 corresponding to the OS 110 resides within the predetermined range that is set in advance as the resource release request reporting condition, the OS 110 is selected as an OS to which the resource release request is reported.

The power saving determination threshold 1412 is a threshold based on the determination whether to perform the power saving control.

The resource release request threshold 1413 is a threshold based on the determination whether to report the resource release request. Note that the above thresholds (i.e., the power saving determination threshold 1412 and the resource release request threshold 1413) are predetermined thresholds contained in the resource information 141.

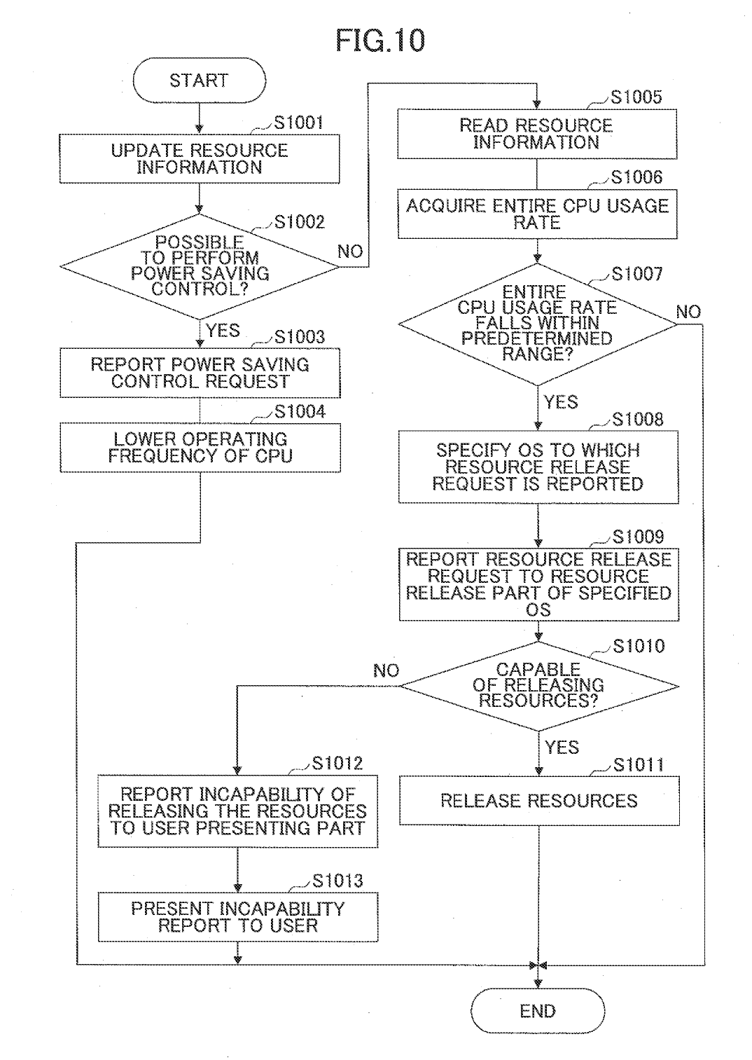

Next, the power saving determination threshold 1412 and the resource release request threshold 1413 are described with reference to FIG. 9. FIG. 9 is a diagram illustrating examples of the power saving determination threshold 1412 and the resource release request threshold 1413 utilized in the information processing apparatus according to the first embodiment. In FIG. 9, (A) illustrates respective usage rates of the CPU 14 for the virtual machines VM1 and VM2, and (B) illustrates a usage rate of the CPU 14 for the entire information processing apparatus 100.

The power saving determination threshold 1412 is a threshold of the CPU usage rate, based on which the power controller 134 determines whether to perform the power saving control. In the first embodiment, if the CPU usage rate of the CPU 14 in the entire information processing apparatus 100 is equal to or lower than the power saving determination threshold 1412, the power controller 134 lowers the operating frequency of the CPU 14 to a predetermined value set in advance.

Note that in the first embodiment, if the CPU usage rate rises up to the predetermined value, the operating frequency of the CPU 14 maybe increased. If the throughput of the CPU 14 is high, degraded processing speed of the CPU 14 maybe suppressed by increasing the operating frequency of the CPU 14.

The resource release request threshold 1413 is a threshold of the CPU usage rate, based on which the release resource specifying part 131 determines whether to report the resource release request. More specifically, the resource release request threshold 1413 is a threshold based on the determination whether the operating frequency of the CPU 14 is greater than the power saving determination threshold 1412 and falls within the predetermined range. In the first embodiment, when the CPU usage rate of the CPU 14 in the entire information processing apparatus 100 is greater than the power saving determination threshold 1412 and lower than the resource release request threshold 1413, the release resource specifying part 131 reports the resource release request.

For example, assume that the power saving determination threshold 1412 is 10% and the resource release request threshold 1413 is 5%. In this case, when the CPU usage rate of the CPU 14 in the entire information processing apparatus 100 is greater than 10% and lower than 15%, the release resource specifying part 131 reports the resource release request.

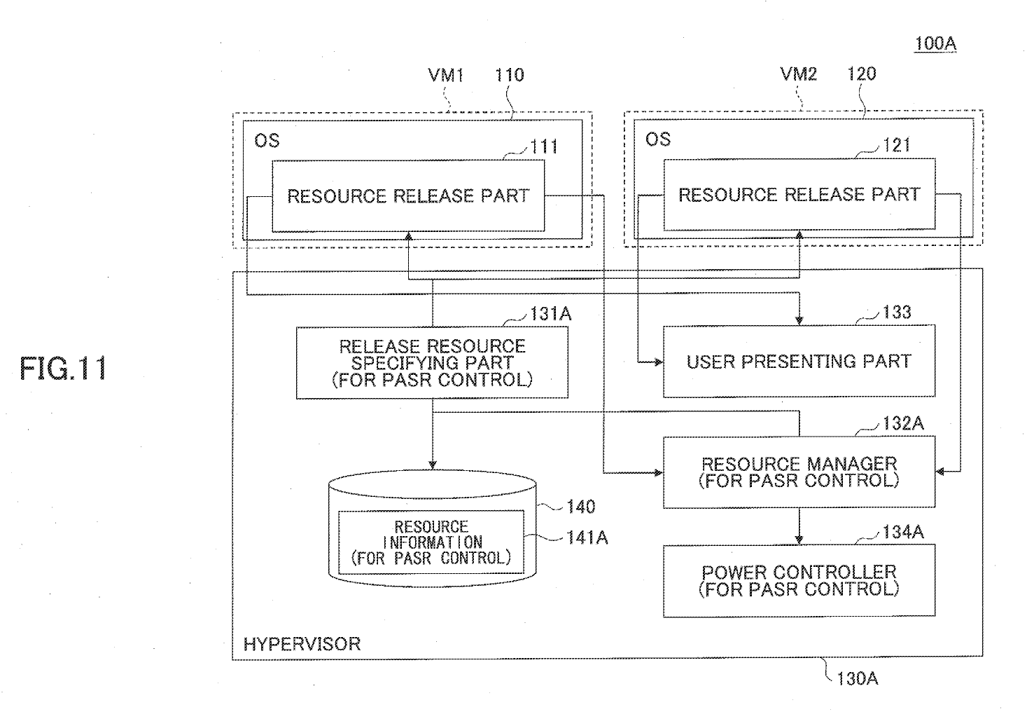

Below, the description is given of the power saving control by referring to the resource information 141 in the information processing apparatus 100 according to the first embodiment. FIG. 10 is a flowchart illustrating an example of the power saving control process by referring to the resource information 141 in the information processing apparatus according to the first embodiment.

In the first embodiment, processes in steps S1001 to S1013 are repeated every predetermined period. The resource manager 132 updates the resource information 141 (step S1001). Specifically, the resource manager 132 allocates the CPU 14 to OS 110 and OS 120, measures the CPU usage rates corresponding to the OS 110 and OS 120, and updates the CPU usage rates corresponding to the OS 110 and OS 120 contained in the resource information 141 based on the measured CPU usage rates.

Subsequently, the resource manager 132 determines whether it is possible to perform the power saving control (step S1002). Specifically, the resource manager 132 determines whether the entire CPU usage rate is equal to or lower than the power saving determination threshold 1412 based on the updated resource information 141.

If the entire CPU usage rate is equal to or lower than the power saving determination threshold 1412 (“YES” in step S1002), the resource manager 132 reports the power saving control request to the power controller 134 (step S1003). On receiving the power saving control request report, the power controller 134 lowers the operating frequency of the CPU 14 (Step S1004). Thereafter, the power controller 134 terminates the process (end of the process in FIG. 10).

If, on the other hand, the entire CPU usage rate is greater than the power saving determination threshold 1412 (“NO” in step S1002), the release resource specifying part 131 reads the resource information 141 from the resource information storage part 140 (step S1005). Subsequently, the release resource specifying part 131 acquires the CPU usage rate of the entire information processing apparatus 100 based on the respective CPU rates of the OS 110 and OS 120 contained in the individual resource information 1411 for the respective OS 110 and OS 120 (step S1006).

Subsequently, the release resource specifying part 131 determines whether the entire CPU usage rate is greater than the power saving determination threshold 1412 and lower than the resource release request threshold 1413 (step S1007). If the entire CPU usage rate is greater than the power saving determination threshold 1412 and lower than the resource release request threshold 1413 (“YES” in step S1007), the release resource specifying part 131 specifies the OS to which the resource release request is reported based on the resource release request reporting condition contained in the individual resource information 1411 for the respective OS 110 and OS 120 (step S1008).

Specifically, if the resource release request reporting condition of the OS 110 is the CPU usage rate of 50% and the resource release request reporting condition of the OS 120 is the CPU usage rate of 30%, the release resource specifying part 131 does not report the resource release request to the OS 120. Note that assume that the OS 110 is specified as an OS to which the resource release request is reported in the following description.

If the entire CPU usage rate is neither greater than the power saving determination threshold 1412 nor lower than the resource release request threshold 1413 (“NO” in step S1007), the release resource specifying part 131 terminates the process (end of the process in FIG. 10).

When the OS to which the resource release request is reported is specified as the OS 110, the release resource specifying part 131 reports the resource release request to the resource release part 111 of the OS 110 (step S1009). Note that the release resource specifying part 131 reports a value of the CPU usage rate subject to lowering to the resource release part 111.

Subsequently, the resource release part 111 of the OS 110 determines whether the power control function of the OS 110 is capable of releasing the resources (step S1010). Specifically, the resource release part 111 determines whether it is possible to lower the CPU usage rate down to the value of the CPU usage rate reported by the release resource specifying part 131.

The power saving control function (power control function) of the OS 110 may include a function to allow the OS 110 to request a manager application that integrates the applications to lower the CPU usage rate. If the manager application terminates one or more of the applications in execution, the CPU usage rate is lowered. Note that in the first embodiment, the CPU usage rate may not be lowered down to the reported value. In the first embodiment, it may be possible to release the resources if the CPU usage rate is lowered by some percentage of the reported value. The percentage may be a predetermined value set in advance. The power saving control function (power control function) of the OS 110 may further include a function to adjust a scheduler's scheduling or extending periods of periodic processes.

If the resource release part 111 determines that it is possible to release the resources (“YES” in step S1010), the resource release part 111 releases the resources and reports to the resource manager 132 that the resources have been released (i.e., resource release report) (step S1011). Note that the CPU usage rate is periodically measured by the hypervisor 130. Thus, even if the resources are released, the resource release part 111 does not report to the resource manager 132 that the resources have been released.

If, on the other hand, the resource release part 111 determines that it is not possible to release the resources (“NO” in step S1010), the resource release part 111 reports incapability of releasing the resources to the user presenting part 133 (step S1012). On receiving the incapability report, the user presenting part 133 prompts a user to release the resources (Step S1013). Specifically, the user presenting part 133 causes the display device 12 to display a message that prompts the user to terminates the application in execution or a message that prompts the user to change the settings for terminating the processes run in the background.

As described above, in the information processing apparatus according to the first embodiment, a CPU usage rate lowering request maybe reported to the corresponding OS that may reduce the usage rate of the CPU 14. Further, in the information processing apparatus according to the first embodiment, the power control function of the OS may be effectively utilized based on the CPU usage rate lowering request report, which may provide an excellent effect on the reduction of the power consumption of the entire information processing apparatus 100.

### Second Embodiment

Next, an information processing apparatus according to a second embodiment is described with reference to the accompanying drawings. In the information processing apparatus according to the second embodiment, a partial array self refresh (PASR) process is utilized as a power control process, which mainly differs from the information processing apparatus according to the first embodiment that utilizes the dynamic voltage and frequency scaling (DVFS) process. Thus, in the second embodiment, the difference between the first and second embodiments is described, and functional components of the second embodiment similar to those of the first embodiment are provided with the same reference numerals and are not described again.

A hardware configuration of an information processing apparatus 100A according to the second embodiment is similar to that of the information processing apparatus 100 according to the first embodiment, and hence the description of the hardware configuration is omitted.

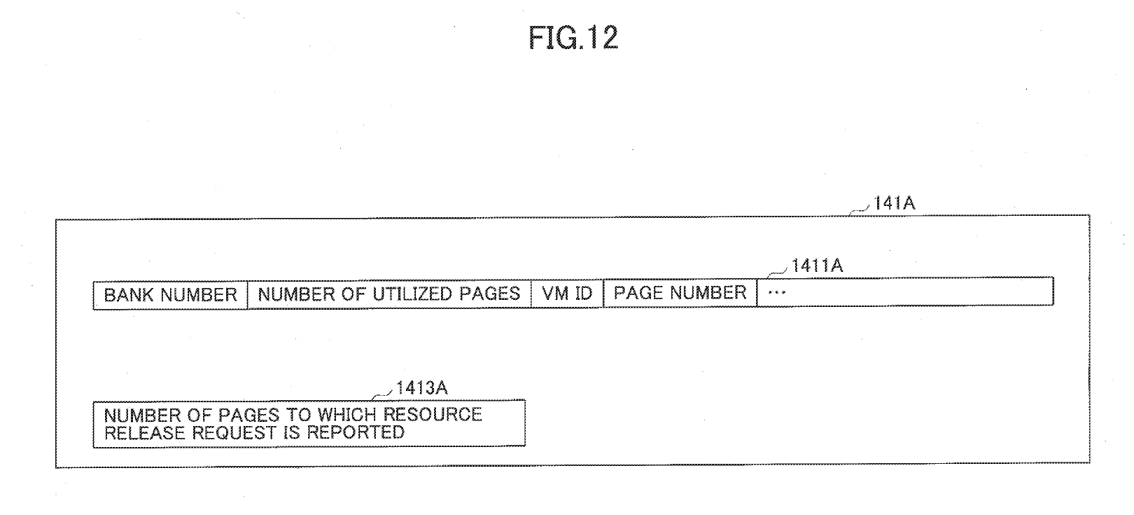

FIG. 11 is a block diagram illustrating a functional configuration example of the information processing apparatus 100A according to the second embodiment.

The information processing apparatus 100A according to the second embodiment includes a hypervisor 130A. The hypervisor 130A includes a release resource specifying part 131A, a resource manager 132A and a power controller 134A. Further, in the information processing apparatus 100A according to the second embodiment, resource information 141A is stored in the resource information storage part 140.

The release resource specifying part 131A is configured to specify an OS, to which the release resource specifying part 131A reports the resource release request, based on resource information 141A for PASR control stored in the resource information storage part 140. The release resource specifying part 131A reports the resource release request to the resource release part of the specified OS. Note that in the second embodiment, the resources indicate memory. The memory utilized in the second embodiment is the main storage device 13 and the auxiliary storage device 16 The resource manager 132A is also configured to manage the resource information 141A. The power controller 134A performs the power saving control process on the information processing apparatus 100A based on the PASR control process.

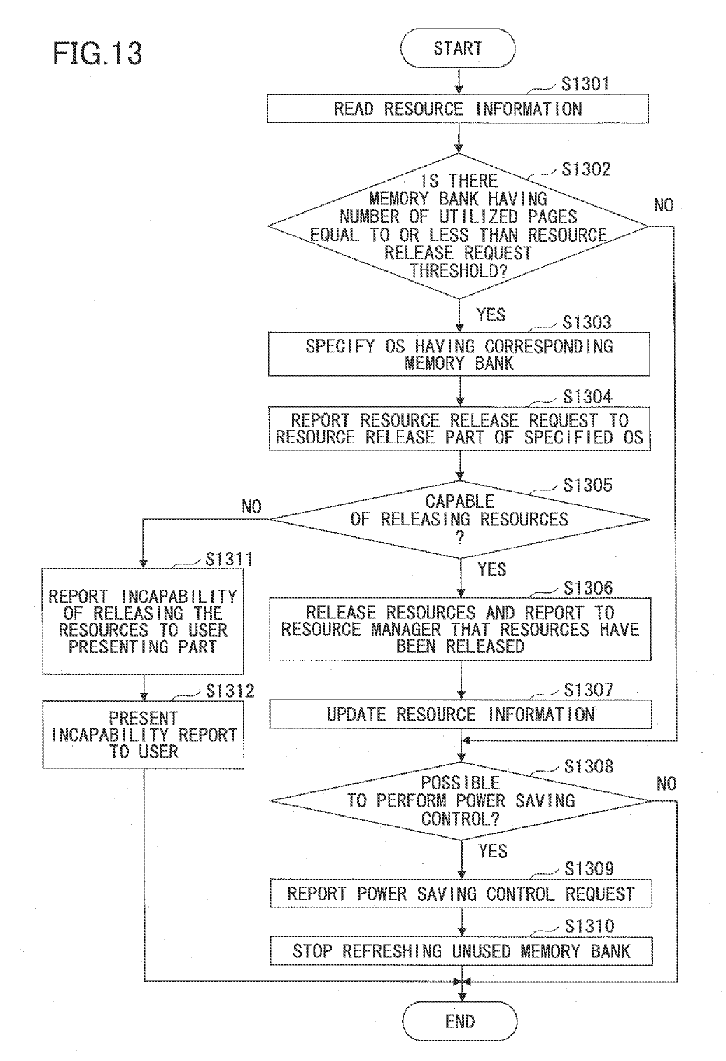

Next, the resource information 141A utilized in the information processing apparatus 100A according to the second embodiment is described below. FIG. 12 is a diagram illustrating an example of the resource information 141A utilized in the information processing apparatus 100A according to the second embodiment.

The resource information 141A utilized in the information processing apparatus 100A according to the second embodiment includes individual resource information 1411A and a resource release request threshold 1413A.

The individual resource information 1411A utilized in the information processing apparatus 100A according to the second embodiment includes usage status information on each memory bank. The individual resource information 1411A includes an ID of each of memory banks, the number of pages utilized by the memory, an ID of the virtual machine that operates an OS utilizing the page, and a page number of the utilized page. The individual resource information 1411A includes the number of combinations of IDs of the virtual machines and the corresponding page numbers based on the number of utilized pages.

The resource release request threshold 1413A is a threshold based on the determination whether to report the resource release request. More specifically, the resource release request threshold 1413A is a threshold based on the determination whether to release a memory to refresh the memory bank as an unused memory bank. Note that the resource release request threshold 1413A is a value indicating the number of utilized pages.

In the second embodiment, the resource release request is reported to the OS that utilizes the memory bank having the number of utilized pages equal to or less than the resource release request threshold 1413A. Note that the resource release request threshold 1413A may be a common value set to all the memory banks, or may be a different value set to each of the memory banks. Note also that the above thresholds are predetermined thresholds contained in the resource information 141A.

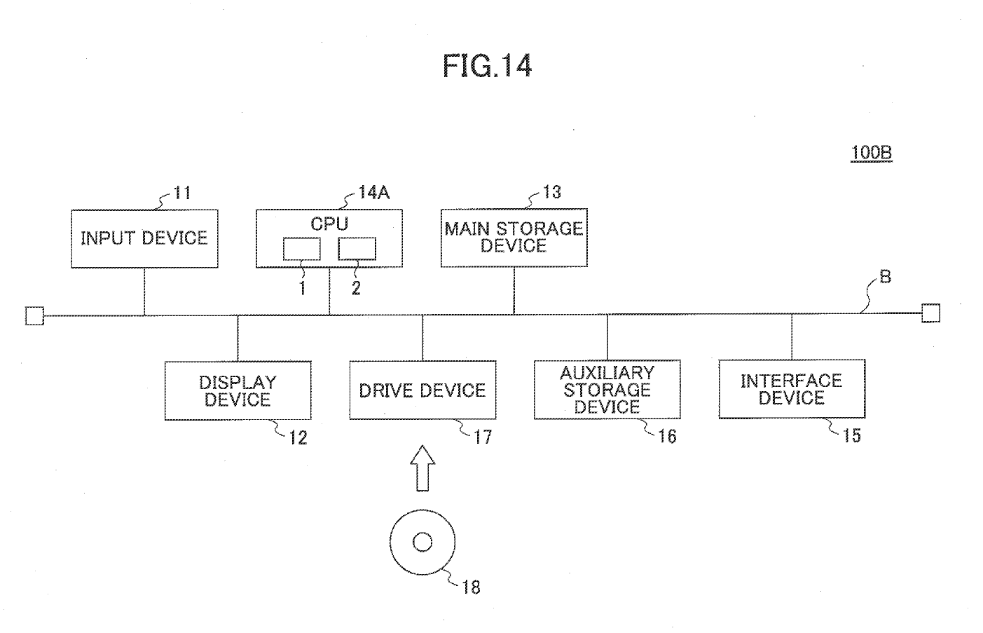

Below, the description is given of the power saving control by referring to the resource information 141A in the information processing apparatus 100A according to the second embodiment. FIG. 13 is a flowchart illustrating an example of the power saving control process by referring to the resource information 141A in the information processing apparatus 100A according to the second embodiment.

The resource manager 132A in the information processing apparatus 100A according to the second embodiment is also configured to execute the following processes when the resource information 141A is updated.

The release resource specifying part 131A of the information processing apparatus 100A according to the second embodiment reads the resource information 141A from the resource information storage part 140 (step S1301). Subsequently, the resource release part 131A determines whether there exists a memory bank having the number of utilized pages equal to or less than the resource release request threshold 1413A in the individual resource information 1411A (step S1302).

Subsequently, if there is a memory bank having the number of utilized pages equal to or less than the resource release request threshold 1413A (“YES” in step S1302), the release resource specifying part 131A specifies an OS utilizing the corresponding memory bank (i.e., memory bank having the number of utilized pages equal to or less than the resource release request threshold 1413A) based on the ID of the virtual machine contained in the individual resource information 1411A (step S1303). In the following description, it is assumed that release resource specifying part 131A has specified the OS 120 that utilizes the corresponding memory bank.

If, on the other hand, there is no memory bank having the number of utilized pages equal to or less than the resource release request threshold 1413A (“NO” instep S1302), the release resource specifying part 131A proceeds with the process in step S1308.

When the OS 120 is specified, the release resource specifying part 131A reports the resource release request to the resource release part 121 of the specified OS 120 (step S1304). Note that the release resource specifying part 131A also reports the page number of the memory (i.e., memory page) subject to being released together with the resource release request to the resource release part 121 of the specified OS 120. The page number of the memory may be the page number of the actual physical memory or the page number of the virtual physical memory provided for the VM1, which is virtualized by the hypervisor 130A.

On receiving the resource release request report, the resource release part 121 of the OS 120 determines whether the power control function of the OS 120 is capable of releasing the resources (step S1305). Specifically, the resource release part 121 of the OS 120 determines whether to empty the specified memory page (to acquire space corresponding to the specified memory page).

If the resource release part 121 determines that it is possible to release the resources (“YES” in step S1305), the resource release part 121 releases the resources and reports to the resource manager 132 that the resources have been released (i.e., the resource release report) (step S1306).

In the second embodiment, the resource release part 121 of the OS 120 may terminate the application utilizing the specified memory to acquire space corresponding to the specified memory page. In this case, the resource release part 121 of the OS 120 may delegate the manager application that integrally manages the applications to terminate the application utilizing the specified memory page. Alternatively, the resource release part 121 of the OS 120 may reallocate utilized areas of the memory to a certain location or release a buffer or a cache to which the memory is allocated to acquire space corresponding to the specified memory page. The reallocation of the memory to the certain location indicates moving the areas utilized by a certain page to areas of another page.

On receiving the resource release request report, the resource manager 132A performs (re)allocation and release of the memory and updates the resource information 141A in the individual resource information 1411A (step S1307). Subsequently, the resource manager 132A determines whether it is possible to perform the power saving control (step S1308). Further, the resource manager 132A determines whether there is any memory bank refreshed as unused memory.

If it is determined that it is possible to perform the power saving control (“YES” in step S1308), the resource manager 132A reports the power saving control request to the power controller 134A (step S1309). On receiving the power saving control request report, the power controller 134 stops refreshing the unused memory bank (Step S1310).

If the resource release part 121 determines that it is not possible to release the resources (“NO” in step S1305), the resource release part 121 reports incapability of releasing the resources to the user presenting part 133 (step S1311). Note that the process in step S1312 is similar to that in step S1013 in FIG. 10, and the corresponding description of the process in FIG. 13 is thus omitted.

In the second embodiment, the resource manager 132A may reallocate utilized areas of the memory to refresh the memory bank as the unused memory bank. Alternatively, the resource manager 132A may move utilized areas of the memory bank having less utilized pages to the memory bank having numerous utilized pages such that the release resource specifying part 131A may be capable of releasing the resources.

As described above, the resource release request is reported to the OS utilizing the memory bank having the number of utilized pages equal to or less than the predetermined number of pages to empty the memory page (i.e., to acquire space corresponding to the memory page) in the information processing apparatus according to the second embodiment. Further, in the information processing apparatus 100A according to the second embodiment, the power control function of the OS maybe effectively utilized based on the memory reallocation (emptying) request, which may provide an excellent effect on the reduction of the power consumption of the entire information processing apparatus 100A.

### Third Embodiment

Next, an information processing apparatus according to a third embodiment is described with reference to the accompanying drawings. The information processing apparatus according to the third embodiment differs from the information processing apparatus according to the first embodiment in that the information processing apparatus according to the third embodiment includes a multi-core CPU. Thus, in the third embodiment, the difference between the first and third embodiments is described, and functional components of the third embodiment similar to those of the first embodiment are provided with the same reference numerals and are not described again.

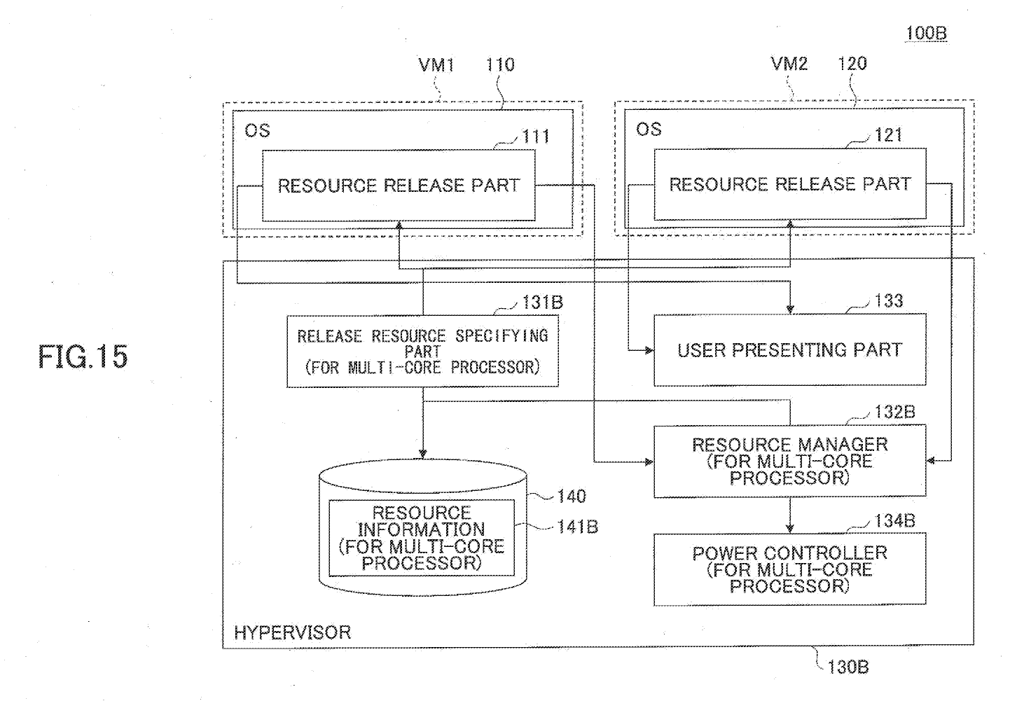

FIG. 14 is a diagram illustrating a hardware configuration example of the information processing apparatus according to the third embodiment.

The information processing apparatus 100B according to the third embodiment includes a CPU 14A of a multi-core processor that encapsulates a plurality of processor-cores sealed within one processor package. In the information processing apparatus 100B according to the third embodiment, the CPU 14A includes a core 1 and a core 2. Note that in the third embodiment, the CPU 14A includes two cores as an example. However, the number of cores contained in the CPU 14A may not be limited to two. The number of cores contained in the CPU 14A may be four or eight.

In the second embodiment, the power is controlled by switching off the power of any one of cores in the CPU 14A.

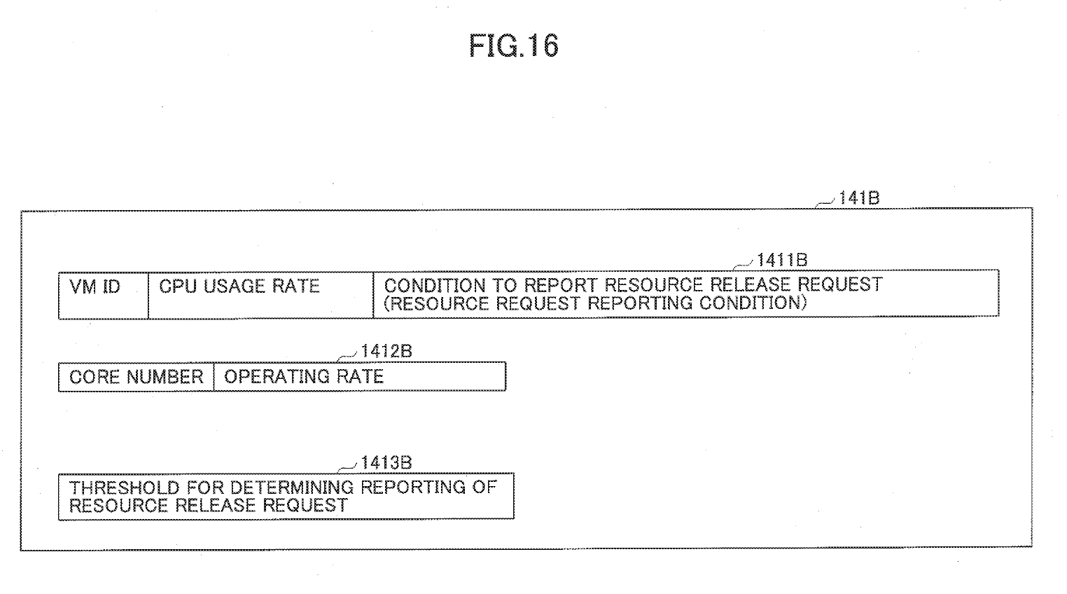

FIG. 15 is a block diagram illustrating a functional configuration example of the information processing apparatus according to the third embodiment. The information processing apparatus 100B according to the second embodiment includes a hypervisor 130B. The hypervisor 130B includes a release resource specifying part 131B, a resource manager 132B and a power controller 134B. Further, in the information processing apparatus 100B according to the third embodiment, resource information 141B is stored in the resource information storage part 140.

The release resource specifying part 131B is configured to specify an OS, to which the release resource specifying part 131B reports the resource release request, based on the resource information 141B stored in the resource information storage part 140. The release resource specifying part 131B reports the resource release request to the corresponding resource release part of the specified OS. The resources in the information processing apparatus according to the third embodiment indicate the CPU 14A.

The resource manager 132B is configured to manage the resource information 141B. The power controller 134B is configured to switch off at least one of the cores contained in the CPU 14A.

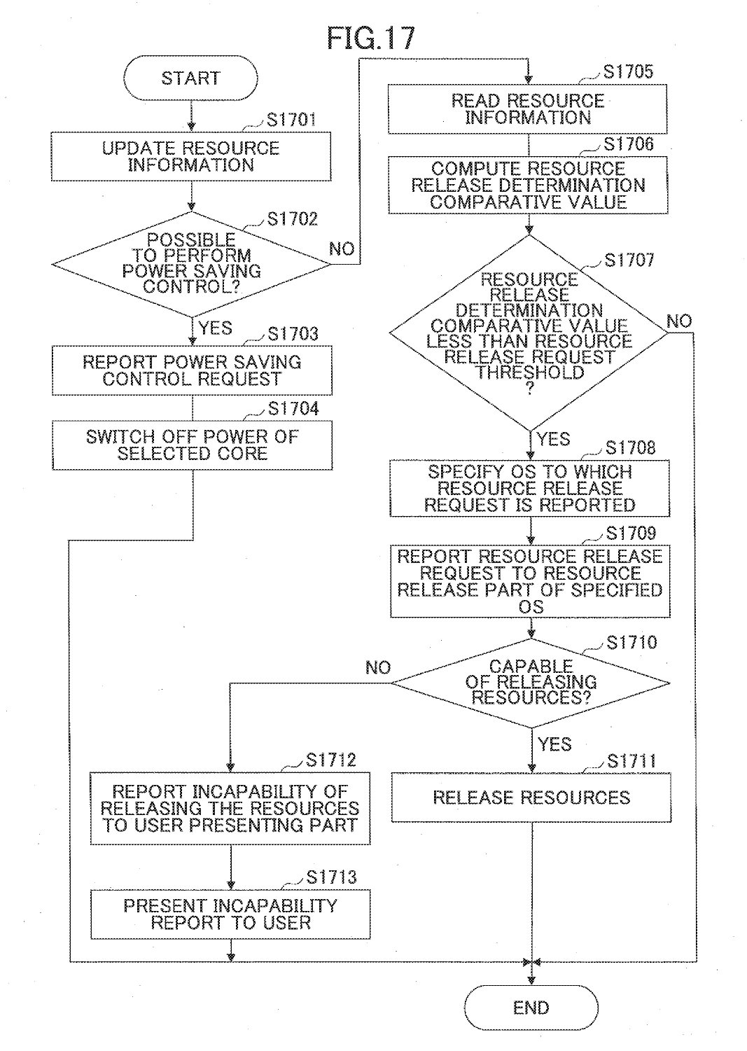

Next, the resource information 141B is described below. FIG. 16 is a diagram illustrating an example of the resource information 141B utilized in the information processing apparatus according to the third embodiment.

The resource information 141B utilized in the information processing apparatus 100B according to the third embodiment includes individual resource information 1411B, a core-based resource information 1412B, and a resource release request threshold 1413B.

The individual resource information 1411B utilized in the information processing apparatus 100B according to the third embodiment is similar to the individual resource information 1411 utilized in the information processing apparatus 100 according to the first embodiment, except that the CPU 14A utilized as the resource in the information processing apparatus 100B according to the third embodiment is a multi-core processor. The individual resource information 1411B includes information indicating the usage status of CPU 14A that is stored corresponding to each OS. The individual resource information 1411B includes identifier information (ID) of the virtual machine, the usage rate of the CPU 14A, and a resource release request reporting condition for reporting the resource release request. Note that the usage rate of the CPU 14A indicates the usage rate of the entire CPU 14A by the respective operating systems.

The core-based information 1412B stored in the resource information 141B is classified by core. The core-based information 1412B utilized in the information processing apparatus according to the third embodiment includes a core number for identifying each core and an operating ratio of the core.

The resource release request threshold 1413B is a threshold based on the determination whether to report the resource release request. In the information processing apparatus 100B according to the third embodiment, it is assumed that the maximum operating ratio of each of the core 1 and core 2 is 100%. In this case, if the total operating ratio of the core 1 and core 2 is divided by 100 and the residual of the obtained result is less than the resource release request threshold 1413B, the resource release request is reported. In the following description, the residual obtained by dividing the total operating ratio of the respective cores by the maximum operating ratio is called a “resource release determination comparative value”. Note that the above thresholds are predetermined thresholds contained in the resource information 141B. The operating ratio of each of the cores illustrated in the third embodiment is 100%; however, the operating ratio of each of the cores may not be limited to 100%. The operating ratio of each of the cores may be 80% or 70%. In such a case, the residual obtained by dividing the total operating ratio of the respective cores by 80 or 70 is utilized as the resource release determination comparative value.

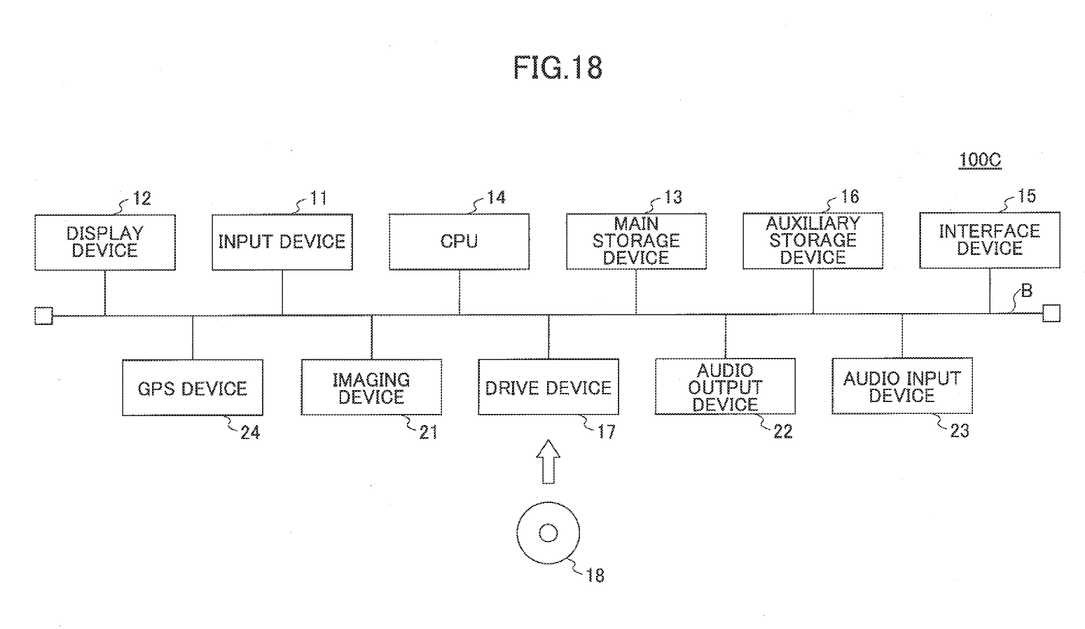

Below, the description is given of the power saving control by referring to the resource information 141B in the information processing apparatus 100B according to the third embodiment. FIG. 17 is a flowchart illustrating an example of the power saving control process by referring to the resource information 141B in the information processing apparatus 100B according to the third embodiment.

In the third embodiment, processes in steps S1701 to S1711 are repeated every predetermined period.

In the information processing apparatus 100B according to the third embodiment, the resource manager 132B updates the resource information 141B (step S1701). Specifically, the resource manager 132B allocates the CPU 14A to the respective operating systems, measures the respective CPU usage rates of the operating systems, and updates the respective CPU usage rates of the operating systems in the individual resource information 1411B. The resource manager 132B also updates the operating ratios of the respective cores in the core-based information 1412B.

Subsequently, the resource manager 132B determines whether it is possible to perform the power saving control (step S1702). Specifically, the resource manager 132B determines that it is possible to perform the power saving control if the total value of the operating ratios of the cores is within n*100% (i.e., within n cores). Note that n represents a number smaller than the number of cores contained in the CPU 14A.

If it is determined that it is possible to perform the power saving control (“YES” in step S1702), the resource manager 132B reports the power saving control request to the power controller 134B (step S1703). Specifically, the resource manager 132B reports to the power controller 134B the power saving control request indicating that the power controller 134B switches off the core other than n cores. In this case, the resource manager 132B may select one or more cores the power of which is to be switched off and report the core number of the selected core to the power controller 134B together with the power saving control request.

The core(s) the power of which is to be switched off may be selected based on the operating ratios of the cores contained in the core-based resource information 1412B. For example, the resource manager 132B may select the core the power of which is to be switched off in the order from the core having the lowest operating ratio to the core having the highest operating ratio. The core may be selected in this fashion and may reduce an adverse effect due to transition of the process in execution to a different core.

On receiving the power saving control request report, the power controller 134B switches off the power of the selected core (Step S1704).

If the resource manager 132B determines that it is not possible to perform the power saving control (“NO” in step S1702), the release resource specifying part 131B reads the resource information 141B from the resource information storage part 140 (step S1705). Subsequently, the release resource specifying part 131B computes the resource release determination comparative value based on the core-based resource information 1412B of the resource information 141B (step S1706).

Further, the resource release specifying part 131B compares the computed resource release determination comparative value and the resource release request threshold 1413B, and determines whether the computed resource release determination comparative value is less than the resource release request threshold 1413B (step S1707).

The description is given below of an example where the CPU 14A in the third embodiment includes four cores each of which has the maximum operating ratio of 100%. In this case, the resource release request threshold 1413B is assumed to be 5%. If the operating ratio of each of the cores in the CPU 14A is 76%, the resource release determination comparative value is the residual of 4% obtained by dividing the total operating ratio of the cores of 304% by the maximum operating ratio of each core of 100%. Thus, it is determined that the resource release determination comparative value is less than the resource release request threshold 1413B.

If the resource release determination comparative value is less than the resource release request threshold 1413B (“YES” in step S1707), the release resource specifying part 131B specifies the OS to which the resource release request is reported based on the resource release request reporting condition contained in the individual resource information 1411B (step S1708). In this case, it is assumed that the release resource specifying part 131B specifies the OS 110.

If the resource release determination comparative value is not less than the resource release request threshold 1413B (“NO” instep S1707), the resource release part 131B terminates the process (end of the process in FIG. 17).

When the OS to which the resource release request is reported is specified as the OS 110, the release resource specifying part 131B reports the resource release request to the resource release part 111 of the OS 110 (step S1709). Note that the release resource specifying part 131B reports the resource release determination comparative value as a value of the CPU usage rate subject to lowering to the resource release part 111.

Note that processes in steps S1710 and S1711 in FIG. 17 are similar to those in steps S1010 and S1011 in FIG. 10, and the corresponding descriptions of the processes in FIG. 17 are thus omitted.

Note that processes in steps S1712 and S1713 subsequent to the process in step S1710 in FIG. 17, in which it is determined that it is not possible to release the resources, are similar to those in steps S1012 and S1013 in FIG. 10, and the corresponding descriptions of the processes in FIG. 17 are thus omitted.

As described above, the hypervisor 130B reports to the corresponding operating systems a power off control request so as to switch off the power of some of the cores contained in the CPU 14A in the information processing apparatus 100B according to the third embodiment. Further, in the information processing apparatus 100B according to the third embodiment, the power control function of the OS may be effectively utilized based on the power off control request, which may provide an excellent effect on the reduction of the power consumption of the entire information processing apparatus 100B.

### Fourth Embodiment

Next, an information processing apparatus according to a fourth embodiment is described with reference to the accompanying drawings. The information processing apparatus according to the fourth embodiment differs from the information processing apparatus according to the first embodiment in that the resources subject to being released are specified as devices in the information processing apparatus according to the fourth embodiment. Thus, in the fourth embodiment, the difference between the first and fourth embodiments is described, and functional components of the fourth embodiment similar to those of the first embodiment are provided with the same reference numerals and are not described again.

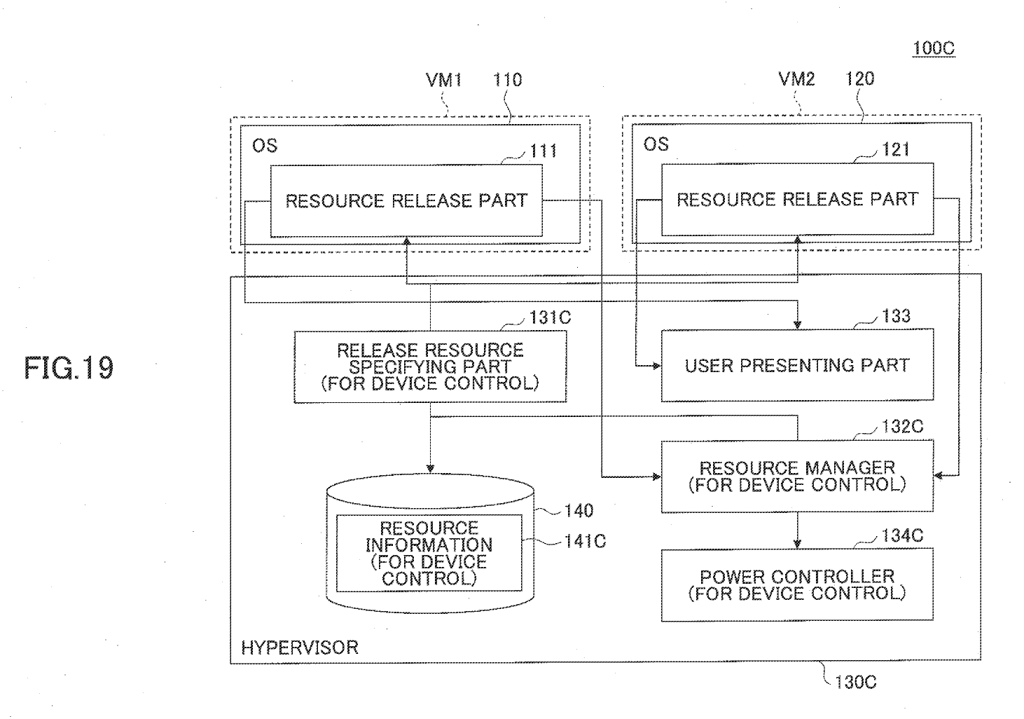

FIG. 18 is a diagram illustrating a hardware configuration example of the information processing apparatus according to the fourth embodiment.

The information processing apparatus 100C according to the fourth embodiment includes an imaging device 21, an audio output device 22, an audio input device 23 and a global positioning system (GPS) device 24. The imaging device 21, the audio output device 22, the audio input device 23 and the GPS device 24 are connected via the bus B to other devices contained in the information processing apparatus 100C such that data are mutually transmitted and received between the devices under the control of the CPU 14.

In the information processing apparatus 100C according to the fourth embodiment, all the devices other than the CPU 14, the main storage device 13 and the auxiliary storage device 16 are treated as the resources subject to being released.

In the fourth embodiment, the power is controlled by switching off the power of any one of such devices contained in the information processing apparatus 100C.

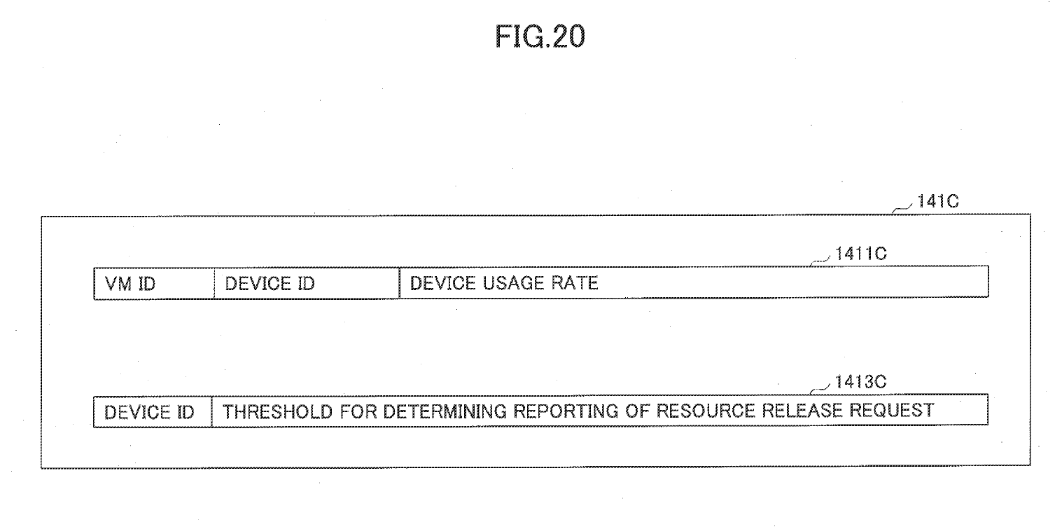

FIG. 19 is a block diagram illustrating a functional configuration example of the information processing apparatus 100C according to the fourth embodiment. The information processing apparatus 100C according to the fourth embodiment includes a hypervisor 130C. The hypervisor 130C includes a release resource specifying part 131C, a resource manager 132C and a power controller 134C. Further, in the information processing apparatus 100C according to the fourth embodiment, resource information 141C is stored in the resource information storage part 140.

The release resource specifying part 131C is configured to specify an OS, to which the release resource specifying part 131C reports the resource release request. The release resource specifying part 131C reports the resource release request to the resource release part of the specified OS.

The resource manager 132C is also configured to manage the resource information 141C. The power controller 134C is configured to switch off the power of the selected device.

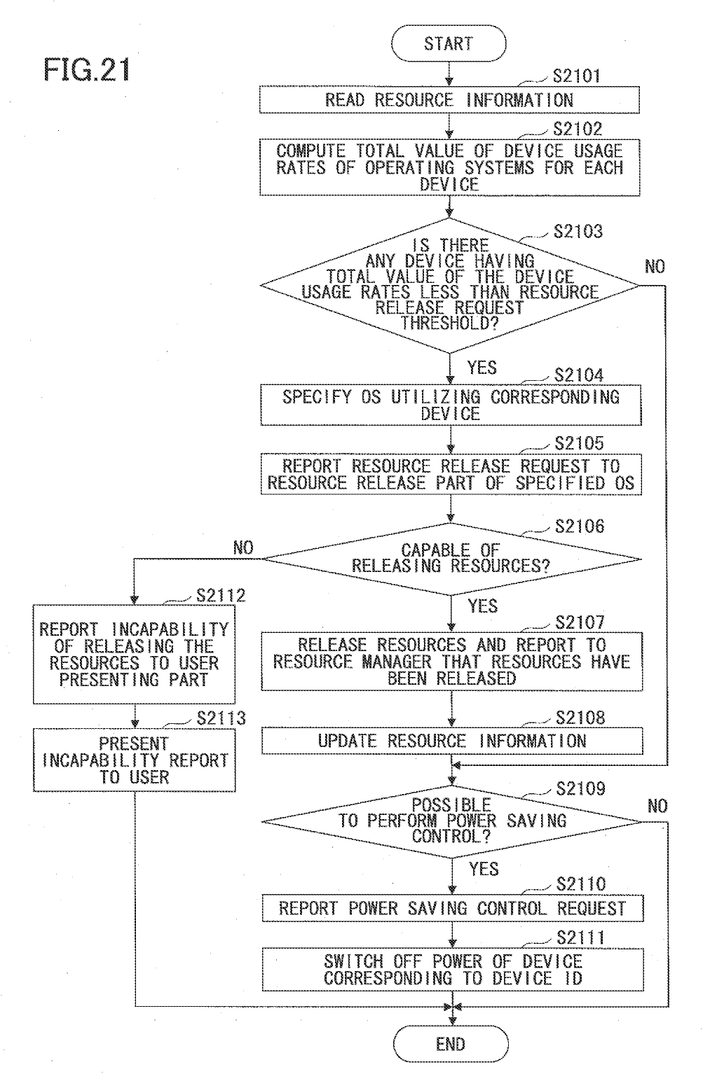

Next, the resource information 141C is described below. FIG. 20 is a diagram illustrating an example of the resource information 141C.

The resource information 141C utilized in the information processing apparatus 100C according to the fourth embodiment includes individual resource information 1411C and a resource release request threshold 1413C.

The individual resource information 1411C includes information indicating usage statuses of the devices that are stored in each of the operating systems (OSs). The individual resource information 1411C includes identifier information (ID) of the virtual machine, a device ID, and a device usage rate by a corresponding OS. The device ID is identifier information uniquely assigned to each device. The device usage rate indicates how much percentage the OS utilizes the device, which is computed based on the number of accesses to the devices per unit time. The device usage rate may be computed as 100% when the device is accessed 100 times per second. In this case, the device usage rate is 5% when the device is accessed 5 times per second.

The resource release request threshold 1413C is a threshold based on the determination whether to report the resource release request. In the fourth embodiment, the resource release request is reported to the OS that utilizes the device having the device usage rate less than the resource release request threshold 1413C. Note that the resource release request threshold 1413C is a predetermined threshold.

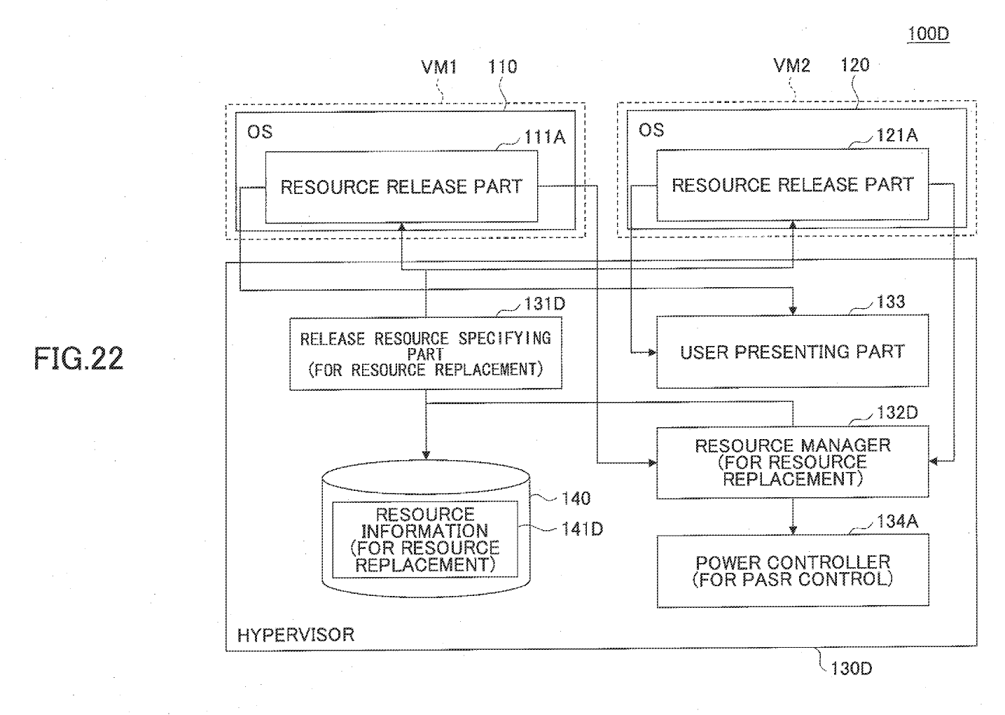

Below, the description is given of the power saving control by referring to the resource information 141C in the information processing apparatus 100C according to the fourth embodiment. FIG. 21 is a flowchart illustrating an example of the power saving control process by referring to the resource information 141C in the information processing apparatus 100C according to the fourth embodiment.

In the fourth embodiment, when the resource information 141C is updated, processes in steps S2101 to S2113 are repeatedly executed.

The release resource specifying part 131C of the information processing apparatus 100C according to the fourth embodiment reads the resource information 141C from the resource information storage part 141 (step S2101). Subsequently, the release resource specifying part 131C computes a total value of the device usage rates of the operating systems for each device based on the individual resource information 1411C of the resource information 141C (step S2102).

Subsequently, the resource release part 131C compares the computed total value of the device usage rates of the operating systems in each device and the resource release request threshold 1413C, and determines whether there is any device having the computed total value of the device usage rates of the operating systems less than the resource release request threshold 1413C (step S2103).

Subsequently, if there is a device having the computed total value of the device usage rates of the operating systems less than the resource release request threshold 1413C (“YES” in step S2103), the release resource specifying part 131C specifies an OS utilizing the corresponding device having the computed total value of the device usage rates of the operating systems less than the resource release request threshold 1413C (step S2104).

For example, if the device usage rate of the imaging device 21 by the OS 110 is 5%, and the device usage rate of the imaging device 21 by the OS 120 is 15%, the (total) device usage rate of the imaging device is 20%. In this case, if the resource release request threshold 1413 is set as 25%, the imaging device 21 is selected as the device subject to being released and the OS 110 and OS 120 utilizing the imaging device 21 are specified as the OS to which the resource release request is reported. Note that in step S2104, it is assumed that the OS 110 is specified.

When the OS to which the resource release request is reported is specified as the OS 110, the release resource specifying part 131C reports the resource release request to the resource release part 111 of the OS 110 (step S2105). The release resource specifying part 131C also reports the device ID subject to being released to the resource release part 111 of the specified OS 110 together with the resource release request.

Subsequently, on receiving the resource release request, the resource release part 111 of the OS 110 determines whether the power control function of the OS 110 is capable of releasing the resources (step S2106). If the resource release part 111 determines that it is possible to release the resources (“YES” in step S2106), the resource release part 111 releases the resources and reports to the resource manager 132C that the resources have been released (step S2107).

Specifically, the resource release part 111 specifies the application utilizing a driver for controlling the device corresponding to the reported device ID and requests the manager application integrating the applications to terminate the specified application. If the specified application is allowed to be terminated, the manager application terminates the application to terminate the use of the driver.

On receiving a report indicating that the resources have been released (resource release report), the resource manager 132C updates the resource information 141C based on the received report (step S2108). Specifically, the resource manager 132C performs allocation and releasing (reallocation) of the device and registers or deletes the device information in the individual resource information 1411C of the resource information 141C. Alternatively, the resource manager 132C may count the number of accesses to the device, compute the device usage rate per predetermined period and update the resource information 141C based on the computed device usage rate.

Subsequently, the resource manager 132C determines whether it is possible to perform the power saving control (step S2109). If it is determined that it is possible to perform the power saving control (“YES” in step S2109), the resource manager 132C reports the power saving control request to the power controller 134C (step S2110). Specifically, the resource manager 132C determines that it is possible to perform the power saving control when the device corresponding to the device ID is not utilized by any of the operating systems (i.e., the device is unused by any of the operating systems). The resource manager 132C also reports the device ID of the device subject to power saving control to the power controller 134C together with the power saving control request.

On receiving the power saving control request report, the power controller 134C switches off the power of the device corresponding to the device ID (Step S2111).

Note that processes in steps S2112 and S2113 subsequent to the process in step S2106 in FIG. 21, in which it is determined that it is not possible to release the resources, are similar to those in steps S1012 and S1013 in FIG. 10, and the corresponding descriptions of the processes in FIG. 21 are thus omitted.

As described above, in the information processing apparatus 100C according to the fourth embodiment, the hypervisor 130C may report a device terminating request corresponding to the device that is less frequently utilized to the corresponding OS. Further, in the information processing apparatus 100C according to the fourth embodiment, the power control function of the OS maybe effectively utilized based on the device terminating request report, which may provide an excellent effect on the reduction of the power consumption of the entire information processing apparatus 100C.

### Fifth Embodiment

Next, an information processing apparatus according to a fifth embodiment is described with reference to the accompanying drawings. The information processing apparatus according to the fifth embodiment differs from the information processing apparatus according to the first embodiment in that the resources are replaced instead of releasing the resources in the information processing apparatus according to the fifth embodiment. Thus, in the fifth embodiment, the difference between the first and fifth embodiments is described, and functional components of the fifth embodiment similar to those of the first embodiment are provided with the same reference numerals and are not described again.

The hardware configuration of an information processing apparatus 100D according to the fifth embodiment is similar to that of the information processing apparatus 100 according to the first embodiment, and hence the description of the hardware configuration is omitted.

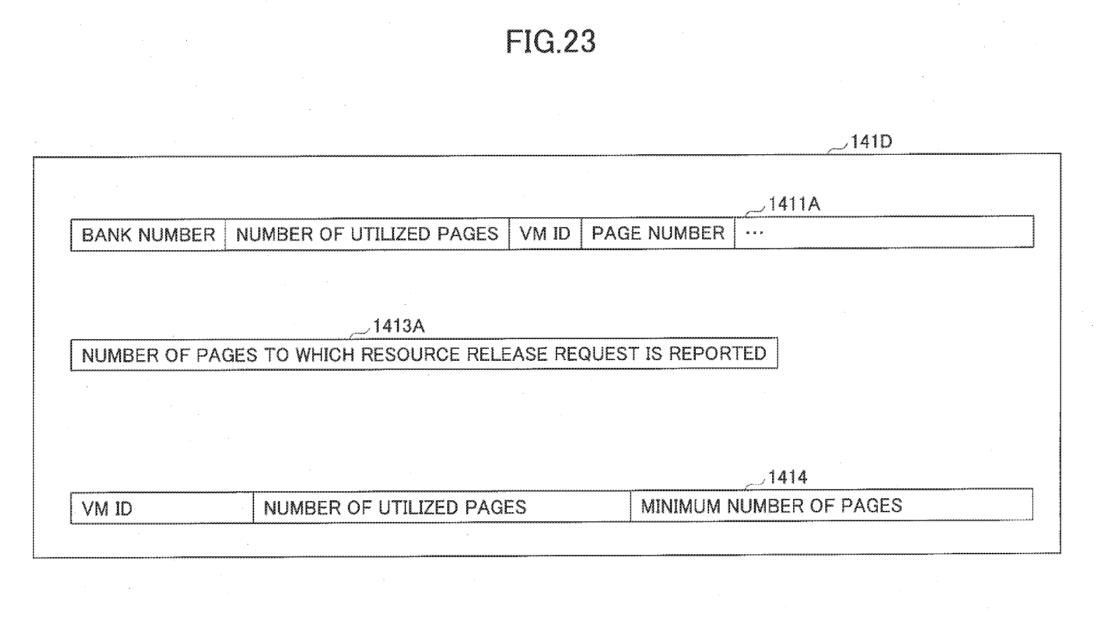

FIG. 22 is a block diagram illustrating a functional configuration example of the information processing apparatus 100D according to the fifth embodiment.

In the information processing apparatus 100D according to the fifth embodiment, the OS 110 includes a resource release part 111A and the OS 120 includes a resource release part 121A. Further, the information processing apparatus 100D according to the fifth embodiment includes a hypervisor 130D. The hypervisor 130D includes a release resource specifying part 131D, a resource manager 132D and a power controller 134D. Further, in the information processing apparatus 100D according to the fifth embodiment, resource information 141D is stored in the resource information storage part 140.

The release resource specifying part 131D is configured to report a resource replacing request as well as the resource release request to the OS 110 and the OS 120. On receiving the resource replacing request, the resource release parts 111A and 121A of the OS 110 and the OS 120 replace the resources by utilizing the respective control functions of the OS 110 and the OS 120.

The resource manager 132D is also configured to manage the resource information 141D. The power controller 134A in the information processing apparatus 100D according to the fifth embodiment performs power saving control process based on the PASR control process in a similar manner as the power saving control process performed on the information processing apparatus 100A.

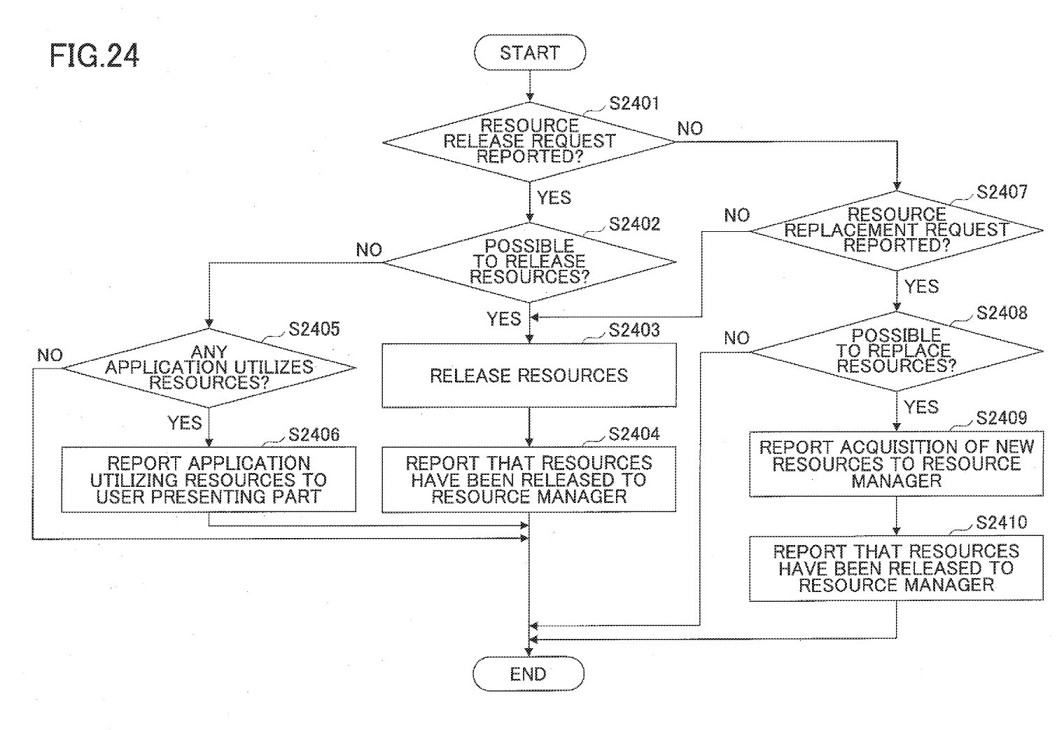

Next, the resource information 141D utilized in the information processing apparatus 100D according to the fifth embodiment is described below. FIG. 23 is a diagram illustrating an example of the resource information 141D. Note that in the fifth embodiment, the resources are memory.

The resource information 141D utilized in the information processing apparatus 100D according to the fifth embodiment includes the individual resource information 1411A and the resource release request threshold 1413A similar to those utilized in the information processing apparatus 100A according to the second embodiment, and further includes a resource replacement request condition 1414. The resource replacement request condition 1414 utilized in the information processing apparatus 100D according to the fifth embodiment is stored in each of the operating systems and is a condition based on which a resource replacement request is reported.

The resource replacement request condition 1414 includes a virtual machine ID (VMID) of each virtual machine that operates a corresponding OS, the number of pages utilized by the OS, and a minimum number of pages that indicates the minimum number of pages necessary for the OS.

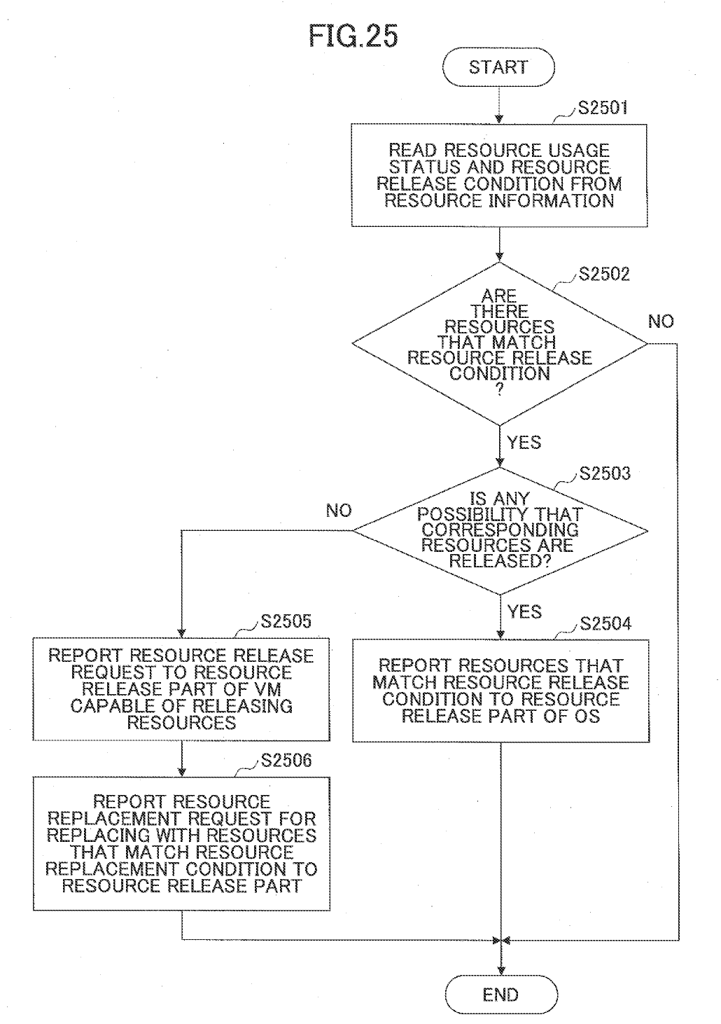

Next, the respective resource release part 111A and 121A contained in the OS 110 and OS 120 utilized in the information processing apparatus 100D according to the fifth embodiment are described below. FIG. 24 is a flowchart illustrating an example of a process carried out by a resource release part in the information processing apparatus 100D according to the fifth embodiment. Note that the resource release parts 111A and 121A in the information processing apparatus 100D according to the fifth embodiment include similar functional configurations. Thus, the process of the resource release part 111A is mainly described as an example of the resource release parts 111A and 121A and description of that of the resource release part 121A is omitted in FIG. 24.

Note that the processes in steps S2401 through S2406 in FIG. 24 are similar to those in steps S31 through S36 in FIG. 3, and the corresponding descriptions in FIG. 24 are thus omitted.

If the resource release request is not reported (“NO” in step S2401), the resource release part 111A determines whether a resource replacement request has been reported (step S2407). If the resource replacement request has not been reported (“NO” in step S2407), the resource release part 111A determines to release the resources based on the normal operation of the OS 110 and proceeds with the process in the step S2403.

If, on the other hand, the resource replacement request has been reported (“YES” in step S2407), the resource release part 111A determines whether it is possible to replace the resources (step S2408). The replacing of resources or the resource replacement indicates substituting other resources for the specified resources.

If the resource release part 111A determines that it is possible to replace the resources (“YES” in step S2408), the resource release part 111A reports acquisition of new resources as substitute resources to the resource manager 132D (step S2409). Subsequently, the resource release part 111A replaces the resources subject to being released with newly acquired resources, reports the resource release report indicating that the resources have been released to the resource manager 132D (step S2410), and terminates the process (end of the process in FIG. 24). If, on the other hand, the resource release part 111A determines that it is not possible to release the resources (“NO” in step S2408), the resource release part 111A terminates the process (end of the process in FIG. 24).

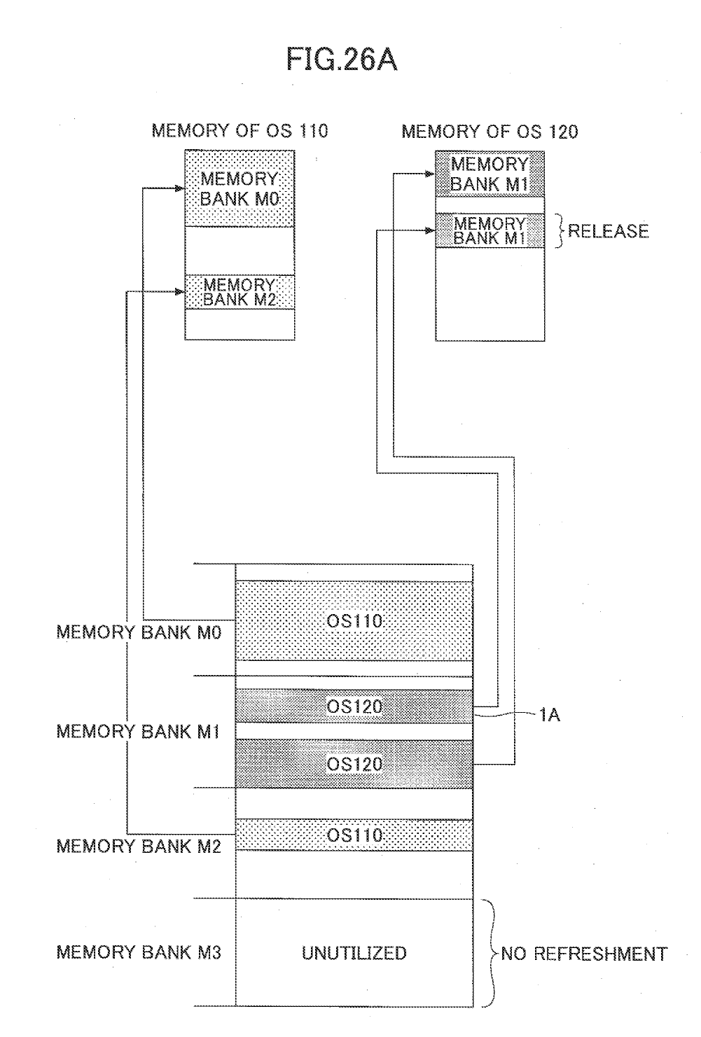

Next, the process of a release resource specifying part 131D is described below. FIG. 25 is a flowchart illustrating an example of a process carried out by the release resource specifying part 131D of the information processing apparatus 100D according to the fifth embodiment.

Note that processes in steps S2501 and S2502 in FIG. 25 are similar to those in steps S41 and S42 in FIG. 4, and the corresponding descriptions of the processes in FIG. 25 are thus omitted.

If there are no resources that match the above resource release condition (“NO” in step S2502), release resource specifying part 131D terminates the process (end of the process in FIG. 25). If there are resources that match the above resource release condition (“YES” in step S2502), the release resource specifying part 131D refers to the resource information 141D to determine whether there is any possibility that the corresponding resources are released (step S2503).

Note that in the fifth embodiment, the resources are memory. The release resource specifying part 131D in the fifth embodiment determines whether there is a memory bank subject to being released. More specifically, the release resource specifying part 131D determines whether there is a memory bank having the number of utilized pages equal to or less than the resource release request threshold 1413A in the individual resource information 1411A (step S2502). If there is a memory bank that matches the above resource release condition (“YES” in step S2502), the release resource specifying part 131D specifies an OS utilizing the memory bank subject to being released and refers to the resource replacement request condition 1414. If the resource replacement request condition 1414 indicates that the number of utilized pages equals the minimum number of pages, the release resource specifying part 131D determines that there is no possibility that the corresponding memory bank is released. If, on the other hand, the resource replacement request condition 1414 indicates that the number of utilized pages is greater than the minimum number of pages, the release resource specifying part 131D determines that there is a possibility that the corresponding memory bank is released (step S2503).

If it is determined that there is a possibility that the corresponding memory bank is released (“YES” in step S2503), the release resource specifying part 131D reports the resource release request to the corresponding resource release part of the OS that utilizes the corresponding memory bank (i.e., resources) (step S2504).

If, on the other hand, it is determined that there is no possibility that the corresponding memory bank is released (“NO” in step S2503), the release resource specifying part 131D reports the resource release request to a resource release part of another OS that utilizes resources that are subject to being replaced with the corresponding memory bank (step S2505).

In the information processing apparatus 100D according to the fifth embodiment, the memory utilized by the operating systems may not be limited to contiguous physical memory. In the fifth embodiment, if the memory is not contiguous physical memory, it is determined that the memory may be replaced with other memory banks.

If other resources subject to replacement are released, the release resource specifying part 131D reports the resource replacement request to the resource release part of the OS that utilizes the resources determined as those incapable of being released in step S2502 (step S2506).

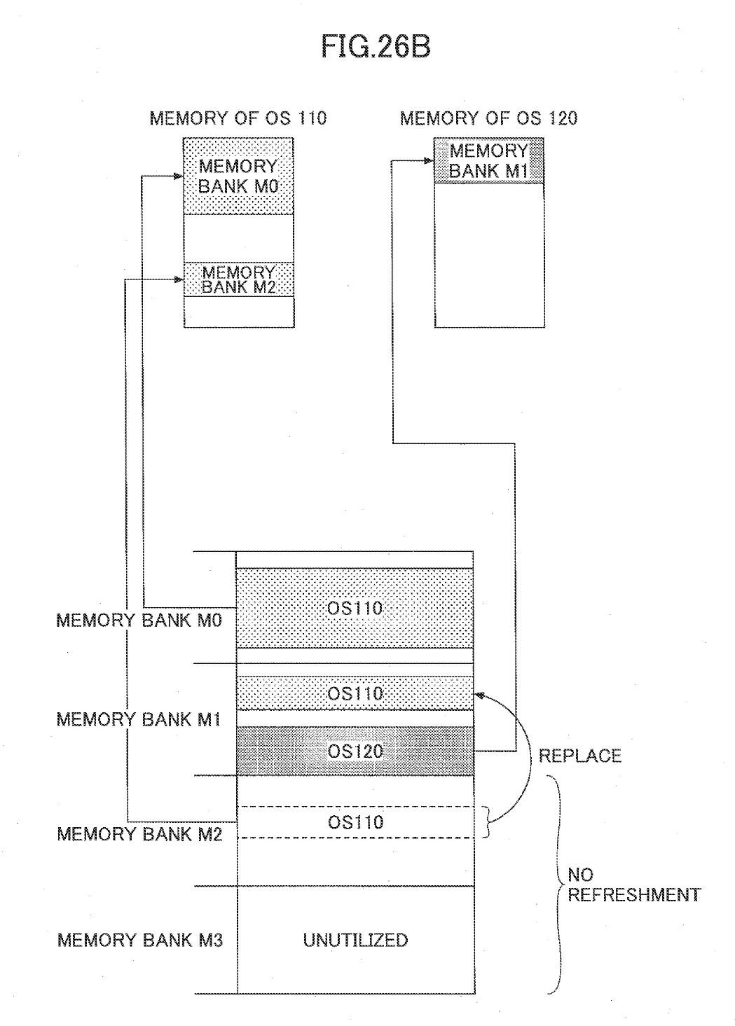

Below, the process in step S2506 is described with reference to FIGS. 26A and 26B. FIGS. 26A and 26B are diagrams illustrating examples of replacement of resources. FIG. 26A is a diagram illustrating a memory status before the replacement and FIG. 26B is a diagram illustrating a memory status after the replacement.

As illustrated in FIGS. 26A and 26B, a memory bank M2 is subject to being released and has the number of utilized pages equal to or less than the resource release request threshold 1413A. Further, the number of utilized pages utilized by the OS 110 is equal to the minimum number of pages, and the number of utilized pages utilized by the OS 120 is greater than the minimum number of pages.

In FIG. 26A, a memory bank M0 and the memory bank M2 are utilized by the OS 110, and a memory bank M1 is utilized by the OS 120.

The release resource specifying part 131D determines that it is not possible for the OS 110 to release the memory bank M2 and reports the resource release request together with the page number of the memory bank M1 to the resource release part 121A. When the OS 120 releases an area 1A of the memory bank M1, the release resource specifying part 131D reports the resource replacement request to the resource release part 111A of the OS 110. At this time, the release resource specifying part 131D reports the resource replacement request together with the page number of the memory bank M2 subject to replacement and the page number of the memory bank M1 that will be replaced with the memory bank M2 as new resources. On receiving the resource replacement request report, the resource release part 111A acquires the area 1A of the memory bank M1 and releases the page of the memory bank M2.

With the above processes, the OS 110 may be capable of utilizing the memory bank M2 as an unused memory bank while maintaining the minimum number of pages as illustrated in FIG. 26B.

Accordingly, the power controller 134 in the information processing apparatus 100D according to the fifth embodiment may stop refreshing the memory bank M2, which may provide an excellent effect on the power saving control of the information processing apparatus 100D.

Note that the information processing apparatuses 100 to 100D according to the first to fifth embodiments maybe implemented in one information processing apparatus. That is, the information processing apparatuses 100 to 100D according to the first to fifth embodiments may be applied to one information processing apparatus.

The processes performed by the above-described components of the information processing apparatuses 100 to 100D according to the first to fifth embodiments may be implemented as a method or as a program stored in a computer-readable medium executed by a computer.

The disclosed information processing apparatuses according to the first to fifth embodiments may be capable of controlling the power to efficiently reduce the power consumption.

The embodiments described so far are not limited thereto. Various modifications or alterations maybe made within the scope of the inventions described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. An information processing apparatus, comprising:
a plurality of operating systems installed therein;
a resource information storage part configured to store resource information including usage status information on hardware resources of the information processing apparatus; and
a controller configured to specify at least one of the operating systems based on the resource information to report a resource release request of a desired one of the hardware resources to the specified operating system and receive a resource release report on the desired hardware resource from the specified operating system to control power associated with the desired hardware resource.

2. The information processing apparatus as claimed in claim 1, wherein
the resource information includes a resource release request threshold utilized for determining whether to report the resource release request, and
the controller includes a release resource specifying part configured to specify at least one of the operating systems to which the resource release request is reported based on a comparison between the usage status information and the resource release request threshold, and a power controller configured to control power consumption associated with the desired hardware resource to reduce the power consumption.

3. The information processing apparatus as claimed in claim 1, wherein
the controller includes a resource manager configured to receive the resource release report on the desired hardware resource from the specified operating system, allocate the desired hardware resource to the specified operating system and update the resource information.

4. The information processing apparatus as claimed in claim 3, wherein
the controller includes a power controller configured to control power consumption of the desired hardware resource, and
the resource manager initially allocates the desired hardware resource to the specified operating system and subsequently reports a power control request to the power controller.

5. The information processing apparatus as claimed in claim 1, wherein
the controller includes a user presenting part configured to present, on receiving a report from the specified operating system indicating that the desired hardware resource is unreleasable, a response to a user indicating that the desired hardware resource is unreleasable.

6. The information processing apparatus as claimed in claim 2, wherein
the usage status information includes usage rates of the hardware resources utilized by the respective operating systems, and
the release resource specifying part specifies at least one of the operating systems to which the resource release request is reported when a sum of the usage rates of the hardware resources utilized by the respective operating systems is less than the resource release request threshold.

7. The information processing apparatus as claimed in claim 3, wherein
the controller includes a release resource specifying part configured to specify at least one of the operating systems to which the resource release request is reported based on a comparison between the usage status information and the resource release request threshold, and a power controller configured to control power consumption associated with the desired hardware resource to reduce the power consumption,
the resource information includes a power saving determination threshold utilized for determining whether to utilize the power controller to control the power consumption associated with the desired hardware resource, and
the release resource specifying part determines to report the resource release request to the specified operating system when the usage rate of the desired hardware resource is equal to or greater than the power saving determination threshold and less than the resource release request threshold.

8. The information processing apparatus as claimed in claim 3, wherein
the controller includes a release resource specifying part configured to specify at least one of the operating systems to which the resource release request is reported based on a comparison between the usage status information and the resource release request threshold, and a power controller configured to control power consumption associated with the desired hardware resource to reduce the power consumption,
the usage status information includes a report request condition based on which the resource release request is reported, and
the release resource specifying part specifies at least one of the operating systems having the usage status information that satisfies the report request condition.

9. The information processing apparatus as claimed in claim 6, wherein
the usage rates of the hardware resources indicate usage rates of a CPU.

10. The information processing apparatus as claimed in claim 9, wherein
the CPU includes a plurality of cores,
the resource information includes operating ratios of the cores,
the usage status information includes a report request condition based on which the resource release request is reported, and
the release resource specifying part specifies at least one of the operating systems having the usage status information that satisfies the report request condition when a resource release comparative value computed based on a total operating ratio of the cores and a maximum operating ratio of the core is less than the resource release request threshold.

11. The information processing apparatus as claimed in claim 3, wherein
the resource information includes a resource release request threshold utilized for determining whether to report the resource release request,
the usage rates of the hardware resources indicate usage rates of devices, and
the release resource specifying part specifies at least one of the operating systems having the usage rate of a corresponding one of the devices being less than the resource release request threshold.

12. The information processing apparatus as claimed in claim 2, wherein
the usage status information includes usage rates corresponding to the hardware resources, and
the release resource specifying part selects at least one of the hardware resources having the usage rate less than the resource release request threshold, and specifies a corresponding one of the operating systems utilizing the selected hardware resource.

13. The information processing apparatus as claimed in claim 12, wherein
each of the usage rates corresponding to the hardware resources indicates a number of utilized pages of a corresponding one of memory banks of a storage device in the information processing apparatus.

14. The information processing apparatus as claimed in claim 12, wherein
the resource information includes a resource replacement request condition utilized for determining whether to replace the selected hardware resource, and
when the release resource specifying part determines that the selected hardware resource utilized by the corresponding operating system is unreleasable based on the resource replacement request condition, the release resource specifying part reports the resource release request to another operating system to release a hardware resource utilized by the other operating system and reports a resource replacement request to the other operating system.

15. A power control method executed by a computer, the power control method comprising:
referring to a resource information storage part storing resource information including respective usage statuses of hardware resources of the computer; and
specifying at least one of operating systems installed in the computer based on the resource information to report a resource release request of a desired one of the hardware resources to the specified operating system and receiving a resource release report on the desired hardware resource from the specified operating system to control power associated with the desired hardware resource.

16. A non-transitory computer-readable medium storing a power control program, which, when processed by a processor, causes a computer to execute the following process, the process comprising:
referring to a resource information storage part storing resource information including respective usage statuses of hardware resources of the computer; and
specifying at least one of operating systems based on the resource information to report a resource release request of a desired one of the hardware resources to the specified operating system and receiving a resource release report on the desired hardware resource from the specified operating system to control power associated with the desired hardware resource.
